(19) United States
(12) Patent Application Publication
(10) Pub. No.: US 2026/0368795 A1
(43) Pub. Date: Nov. 19, 2026

(54) SYSTEMS AND METHODS FOR MULTI-MODAL PRODUCT SEARCHING

(71) Applicant: visualAI retail solutions, inc., Livermore, CA (US)

(72) Inventor: Joseph MONASTIERO, Livermore, CA (US)

(73) Assignee: visualAI retail solutions, inc., Livermore, CA (US)

(21) Appl. No.: 19/211,109

(22) Filed: May 16, 2025

(51) Int. Cl. G06Q 30/0601

(52) U.S. Cl. CPC G06Q 30/0627; G06Q 30/0641

(57) ABSTRACT

A method for multi-modal product searching includes receiving a product search query comprising a desired product description and a color selection, generating a text embedding based on the desired product description and a selected color vector based on the color selection, searching a database of products, wherein searching the database of products comprises calculating a first similarity score between the text embedding and stored product text embeddings, calculating a second similarity score between the selected color vector and stored product color vectors, and calculating combined scores comprising weighted sums of the first similarity score and the second similarity score, and returning at least one search result to the user based on the combined scores.

### FIELD

This application relates generally to searching of products on e-commerce platforms, and more specifically to systems and methods for multi-modal product searching.

### BACKGROUND

E-commerce platforms provide virtual storefronts at which users can browse for and purchase products. To find a desired product, a user may search the e-commerce platform using keyword searching or keyword-based semantic searching. In keyword searching, search results are returned to the user that have the keywords searched by the user or that have keywords synonymous with the keywords searched by the user. Conversely, in keyword-based semantic searching, search results are returned to the user that have keywords largely similar to the intention or context of the keywords searched by the user.

Keyword searching and keyword-based semantic searching can be inefficient and ineffective in providing a user with search results that are most relevant to the user. Keyword and keyword-based semantic searching is often limited by the human-crafted descriptions of products maintained within the product database of the e-commerce platform. Such descriptions can be inaccurate or incomplete. Further, users often must choose their searches carefully by choosing keywords that are most likely to match the product descriptions. Such challenges with keyword and keyword-based semantic searching can results in user dissatisfaction and search abandonment, leading to a substantial loss of revenue for the e-commerce platform.

### SUMMARY

According to an aspect, systems and methods provide multi-modal product searching that enables a user to search for products using a combination of natural language and color selection. A user may submit a product search query that includes a natural language description directed to a desired product and a desired color selection. The desired product description can be converted into a text embedding and the color selection may be converted to a color vector. The text embedding and selected color vector can be searched against a database of products. The database of products may include text embeddings generated from product descriptions and/or product images and color vectors associated with dominant colors within product images. Similarities between the product embeddings and color vectors and the search embedding and selected color vector can be determined to identify the relevant search results. The similarities between the products and the text embedding and the selected color vector may be determined by calculating a weighted sum of a cosine distance between a stored product text embedding of each product and the text embedding of the query and a cosine distance between stored product color vectors of each product and the selected color vector of the query. Search results can be returned to a user based on the determined similarities.

According to some aspects, a method for multi-modal product searching includes receiving a product search query comprising a desired product description and a color selection, generating a text embedding based on the desired product description and a selected color vector based on the color selection, searching a database of products, wherein searching the database of products comprises calculating a first similarity score between the text embedding and stored product text embeddings, calculating a second similarity score between the selected color vector and stored product color vectors, and calculating combined scores comprising weighted sums of the first similarity score and the second similarity score, and returning at least one search result to the user based on the combined scores.

The first similarity score, the second similarity score, or both, may be a Euclidean distance, a cosine distance, or a Jaccard distance. The color selection may be in a red-green-blue color model, and wherein generating the selected color vector may comprise converting from the red-green-blue color model to a hue-saturation-value color model, wherein the selected color vector may comprise a sine of hue and a cosine of hue.

An entry for a product in the database of products may comprise a plurality of stored product color vectors. The plurality of stored product vectors may comprise at least three stored product color vectors. For a product in the database of products, a stored product text embedding for the product may comprise an embedding generated by using a language model to generate a description from an image of the product. For a product in the database of products, each stored product color vector for the product may have been generated by masking skin from an image of the product.

The method may include determining whether the desired product description comprises a category, a brand, a price, or at least one feature of the desired product prior to generating the text embedding based on the desired product description. If the desired product description comprises the category, brand, price, or at least one feature of the desired product, searching the database of products may comprise filtering out products from the database of products that do not comprise the category, brand, price, or at least one feature of the desired product. A weight applied to the first similarity score may be larger than a weight applied to the second similarity score.

According to some aspects, a computing system for multi-modal product searching includes one or more processors and memory storing one or more programs, the one or more programs including instructions that when processed by the one or more processors cause the computing system to receive a product search query comprising a desired product description and a color selection, generate a text embedding based on the desired product description and a selected color vector based on the color selection, search a database of products, wherein searching the database of products comprises calculating a first similarity score between the text embedding and stored product text embeddings, calculating a second similarity score between the selected color vector and stored product color vectors, and calculating combined scores comprising weighted sums of the first similarity score and the second similarity score, and return at least one search result to the user based on the combined scores.

The first similarity score, the second similarity score, or both, may be a Euclidean distance, a cosine distance, or a Jaccard distance. The color selection may be in a red-green-blue color model, and generating the selected color vector may comprise converting from the red-green-blue color model to a hue-saturation-value color model, wherein the selected color vector may comprise a sine of hue and a cosine of hue.

An entry for a product in the database of products may comprise a plurality of stored product color vectors. The plurality of stored product color vectors may comprise at least three stored product color vectors. For a product in the database of products, a stored product text embedding for the product may comprise an embedding generated by using a language model to generate a description from an image of the product. For a product in the database of products, each stored product color vector for the product may have been generated by masking skin from an image of the product.

The one or more programs may include instructions that when processed by the one or more processors cause the computing system to determine whether the desired product description comprises a category, a brand, a price, or at least one feature of the desired product prior to generating the text embedding based on the desired product description. If the desired product description comprises the category, brand, price, or at least one feature of the desired product, searching the database of products may comprise filtering out products from the database of products that do not comprise the category, brand, price, or at least one feature of the desired product. A weight applied to the first similarity score may be larger than a weight applied to the second similarity score.

According to some aspects, a method for multi-modal product searching includes, at a computing system receiving data associated with a product from a product data source, the data comprising a text description of a product and at least one image of the product, generating an enriched description of the product by processing the text description and the at least one image by a language model, generating at least one embedding based on the enriched description of the product, and updating an entry for the product in a database with the embedding.

The at least one embedding may comprise an embedding generated from the enriched description of the product and the text description of the product. The method may include generating an embedding based on the at least one image of the product. The method may include receiving a search query from a user and determining a relevance of the product to the search query based on the embedding. The method may include generating at least one product color vector from the at least one image of the product. The product data source may comprise an e-commerce system. Generating an enriched description of the product by processing the text description and the at least one image by a language model may comprise exchanging a series of prompts and responses with the language model.

According to some aspects, a computing system for multi-modal product searching includes one or more processors and memory storing one or more programs, the one or more programs including instructions that when processed by the one or more processors cause the computing system to receive data associated with a product from a product data source, the data comprising a text description of a product and at least one image of the product, generate an enriched description of the product by processing the text description and the at least one image by a language model, generate at least one embedding based on the enriched description of the product, and update an entry for the product in a database with the embedding.

The at least one embedding may comprise an embedding generated from the enriched description of the product and the text description of the product. The one or more programs may include instructions that when processed by the one or more processors cause the computing system to generate an embedding based on the at least one image of the product. The one or more programs may include instructions that when processed by the one or more processors cause the computing system to receive a search query from a user and determine a relevance of the product to the search query based on the embedding. The one or more programs may include instructions that when processed by the one or more processors cause the computing system to generate at least one product color vector from the at least one image of the product. The product data source may comprise an e-commerce system. Processing the text description and the at least one image by a language model may comprise exchanging a series of prompts and responses with the language model.

### BRIEF DESCRIPTION OF THE FIGURES

The invention will now be described, by way of example only, with reference to the accompanying drawings, in which:

FIG. 1 shows a system configured for multi-modal product searching, according to some embodiments.

FIG. 2 shows a method for performing a multi-modal product search, according to some embodiments.

FIG. 3A shows a product search graphical user interface (GUI) with a product search query that includes a product description and a color selection of a desired product, according to some embodiments.

FIG. 3B shows a color selection that includes a plurality of dominant colors of a desired product, according to some embodiments.

FIG. 3C shows a first product search GUI configured for entering a desired product description and a second product search GUI configured for selecting a color selection of a desired product, according to some embodiments.

FIG. 4 shows a method for generating a plurality of stored product color vectors for a product of a database of products, according to some embodiments.

FIG. 5 shows search results in accordance with a product search query that includes a product description and a color selection of a desired product, according to some embodiments.

FIG. 6A shows a method for performing a first product search using a first product search query that includes a desired product description, according to some embodiments.

FIG. 6B shows a method for performing a second product search using a second product search query that includes a color selection, according to some embodiments.

FIG. 7 shows a method for generating a database of products by generating a multi-modal searchable product entry for each product, according to some embodiments.

FIG. 8A shows a database of products with a first multi-modal searchable product entry, a second exemplary multi-modal searchable product entry, and a third exemplary multi-modal searchable product entry that each include product data and a product image, according to some embodiments.

FIG. 8B shows a database of products with a first multi-modal searchable product entry, a second multi-modal searchable product entry, and a third multi-modal searchable product entry that each include product data, a product image, and enriched product data, according to some embodiments.

FIG. 8C shows a database of products with a first multi-modal searchable product entry, a second multi-modal searchable product entry, and a third multi-modal searchable product entry that each include product data, a product image, enriched product data, and a plurality of product color vectors, according to some embodiments.

FIG. 8D shows a database of products with a first multi-modal searchable product entry, a second multi-modal searchable product entry, and a third multi-modal searchable product entry that each include product data, a product image, enriched product data, a plurality of product color vectors, and a color name, according to some embodiments.

FIG. 8E shows a database of products with a first multi-modal searchable product entry, a second multi-modal searchable product entry, and a third multi-modal searchable product entry that each include product data, a product image, enriched product data, a plurality of product color vectors, a color name, and at least one data embedding, according to some embodiments.

FIG. 9 shows a method for enriching product data by determining a product gender, product category, and product subcategory, and generating an enriched product description using an LM configured to enrich product data, according to some embodiments.

FIG. 10 shows a computing unit, according to some embodiments.

### DETAILED DESCRIPTION

Disclosed herein are examples of systems and methods for multi-modal product searching, in which products of a database of products are identified that are in accordance with a text embedding and a selected color vector of a product search query. A user may submit a product search query that includes a product description of a product desired by the user and a color selection indicating a color that the user would like the product to have. The desired product description may be a natural language description of the desired product and may include reference to one or more categories, a brand, a price, one or more features, a gender, a style, an occasion, or any other information relevant to a search for the desired product. The color selection may be selected from a color model and/or a color name.

The desired product description of the received product search query may be encoded into a text embedding using machine learning. The text embedding may be a multi-dimensional vector that represents the contextual meaning of the desired product description. The color selection of the received product search query may be encoded into a color vector. The color vector may also be a multi-dimensional vector that represents the color properties of the color selection. The database of products may then be searched to determine at least one product that is similar to the text embedding and the color vector. For instance, a first similarity score may be determined between the text embedding and a stored product text embedding for products in the database and a second similarity score may be determined between the color vector and stored product color vectors for products in the database. A combined score may be calculated as a weighted sum of the first similarity score and the second similarity score, and the products of the database of products may be ranked based on the combined score—e.g., a product with a high ranking based on the combined score may be more similar to the product search query than a product with a low ranking based on the combined score. Search results may be returned to the user based on the product ranking.

For a given product, the database may have stored product color vectors that encode multiple dominant colors of the product. The dominant colors of the product may be determined using machine learning, such as machine learning clustering, which identifies clusters of color model values of an image of the product. Optionally, prior to determining the dominant colors, the image may be processed by minimizing or eliminating any non-product features of the image, such as by removing a background of the image, masking skin colors in the image, and/or cropping the image. The location of each cluster identified by the machine learning clustering, such as a plurality of color model values marking a center of each cluster, may represent a dominant color of the product in the processed image. Each identified dominant color may be encoded into a stored product color vector by encoding the plurality of color model values marking the center of the cluster representing the dominant color. For instance, a dominant color represented by a plurality of hue-saturation-value (HSV) color model values may be encoded into a four-dimensional stored product color vector, in which a first dimension encodes a first HSV color model value as the cosine of the hue (e.g., cos(hue)) of the dominant color, a second dimension encodes the first HSV color model value as the sine of the hue (e.g., sin(hue)) of the dominant color, a third dimension encodes a second HSV color model value as the saturation, or a normalized saturation, of the dominant color, and a fourth dimension encodes a third HSV color model value (or brightness) as the value, or a normalized value, of the dominant color.

For a given product, the database may have a stored product text embedding that encodes various textual information associated with the product, such as product data, enriched product data, and/or a color name of one or more dominant colors of the product. The product data may be any data associated with the product and provided by a merchant associated with the product. For instance, the product data may include a product name, product brand, product price, product price variants, product description, and/or product tags. The enriched product data may be generated by a language model (LM), such as a large language model (LLM), that is configured to enrich the product data with previously unknown or previously only visually depicted product characteristics using prompt engineering, in which prompts provided to the LM are specifically engineered to produce outputs that enrich the product data. For instance, the prompt engineering may guide the LM to enrich the product data by determining one or more characteristics of the product, such as a product gender, a product category, and/or a product subcategory. The LM may provide an enriched product description, which is a natural language description of the product and can include various characteristics of the product, such as a style of the product, an occasion at which the product is used, worn, or otherwise interacted with, and/or distinctive features of the product in natural language. The color name that may be encoded in a stored product text embedding may be a color name of a dominant color of the product that was identified via the machine learning clustering.

In some embodiments, each product has a plurality of stored product text embeddings. For instance, each product may have a first stored product text embedding that encodes the product data and at least one dominant color name, a second stored product text embedding that encodes the enriched product data, and a third stored product text embedding that encodes the product data, the enriched product data, and at least one dominant color name.

By performing searches for relevant products using text embeddings and/or color vectors, more relevant search results can be provided to a user without requiring the user to be an expert at searching for the product. The user does not have to know the keywords or combination of keywords that will provide the most relevant results, as would otherwise be required via keyword or keyword-based semantic searching. Further, searching based on text embeddings and/or color vectors, according to the approaches described herein, can be much faster than keyword or keyword-based semantic searching, leading to improved systems for product searching. Search results can be returned more quickly to users and searching can be performed with less processing power.

According to various aspects, the systems and methods described herein can provide improved product search results by enriching product descriptions. Rather than relying on product descriptions provided by a merchant, which may be sparse, incomplete, or inaccurate, the systems and methods described herein can include a more fulsome product description by using machine learning to enrich the data provided by a merchant. For example, an LM can be used to generate enriched product data from an image of the product. By enriching product descriptions and creating embeddings from the enriched product descriptions the systems and methods described herein can provide more relevant search results than searches performed on merchant-provided data.

The following description sets forth exemplary systems, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

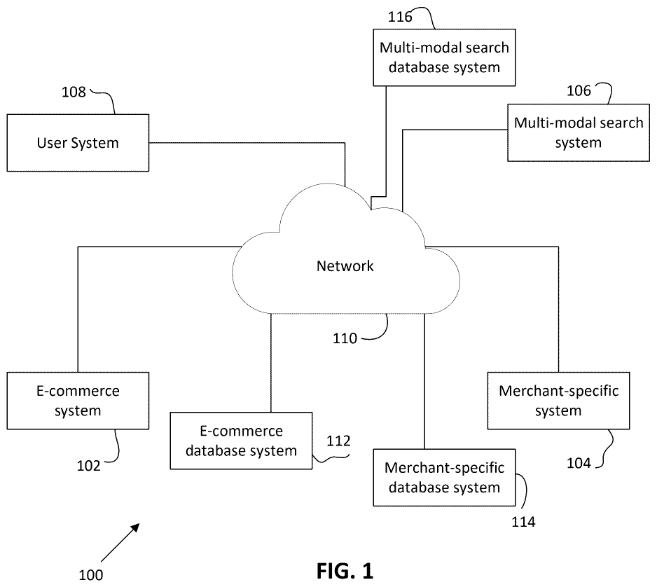

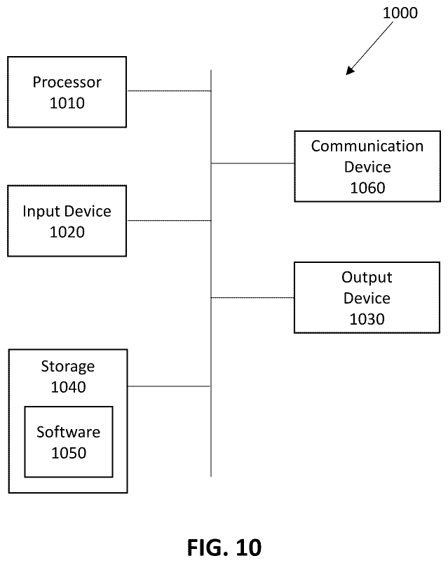

FIG. 1 is an exemplary system 100 for multi-modal product searching. The system 100 may include an e-commerce system 102 configured to support and/or develop a plurality of merchant virtual storefronts (e.g., each virtual storefront displays products associated with one or more merchants). For instance, the e-commerce system 102 may store, maintain, and develop a plurality of databases of merchant-specific products (e.g., each database of products is specific to products of a given merchant), to process product transactions (e.g., product purchases) from the plurality of merchant virtual storefronts, etc. The e-commerce system 102 may include one or more computing units, such as computing unit 1000 of FIG. 10. In some embodiments, an e-commerce database system 112 is configured to store, maintain, and/or develop the plurality of databases of merchant-specific products. For instance, the e-commerce database system 112 may be a cloud computing system with a plurality of cloud databases, such that each cloud database is associated with a given merchant. The e-commerce system 102 and the e-commerce database system 112 may communicatively couple via a network 110 (e.g., via any combination of wired and/or wireless communication protocols or interfaces, such as an application programming interface (API)). As such, the e-commerce system 102 may manage, access, or otherwise interact with the e-commerce database system 112, and thus the plurality of databases of merchant-specific products, via the network 110.

The system 100 may include a merchant-specific system 104, which may be configured to provide a merchant-specific virtual storefront (e.g., a virtual storefront specific to a merchant using the merchant-specific system 104). For instance, the merchant-specific system 104 may be used to store, maintain, and develop a database of merchant-specific products (e.g., products specific to the merchant), to process product transactions from the merchant-specific virtual storefront, etc. The merchant-specific system 104 may include one or more computing units, such as computing unit 1000 of FIG. 10. In some embodiments, a merchant-specific database system 114 is configured to store, maintain, and/or develop the database of merchant-specific products. For instance, the merchant-specific database system 114 may be a cloud computing platform with a cloud database, such that the cloud database is associated with the merchant. The merchant-specific system 104 and the merchant-specific database system 114 may communicatively couple via the network 110 (e.g., via any combination of wired and/or wireless communication protocols or interfaces, such as an API). In some embodiments, the merchant-specific system 104 (or the merchant-specific database system 114) and the e-commerce system 102 (or the e-commerce database system 112) may communicatively couple via the network 110, such that the e-commerce system 102 (or the e-commerce database system 112) may receive the merchant-specific product data and/or the merchant-specific product images from the merchant-specific system 104 (or the merchant-specific database system 114).

The system 100 may include a multi-modal search system 106, which may be configured to maintain at least one database of multi-modal searchable products based on merchant-specific product data (e.g., data associated with products of a given merchant) and merchant-specific product images (e.g., images of products of a given merchant). Multi-modal searchable products may be merchant-specific products that have been processed such that the multi-modal searchable products may be searched against a single-mode product search query, such as a text-based product search query or a color-based product search query, and/or a multi-modal product search query, such as a text-based and color-based product search query. The multi-modal search system 106 may be configured to receive single-mode product search queries and/or multi-modal product search queries representing a product desired by a user. The multi-modal search system 106 may respond to a received product search query (e.g., single-mode or multi-modal) by identifying and outputting at least one multi-modal searchable product in accordance with the received product search query. The multi-modal search system 106 may include one or more computing units, such as computing unit 1000 of FIG. 10. In some embodiments, a multi-modal search database system 116 is configured to store, maintain, and/or develop the at least one database of multi-modal searchable products. For instance, the multi-modal search database system 116 may be a cloud computing platform with at least one cloud database, such that the at least one cloud database is the at least one database of multi-modal searchable products. The multi-modal search system 106 and the multi-modal search database system 116 may communicatively couple via the network 110 (e.g., via any combination of wired and/or wireless communication protocols or interfaces, such as an API).

The multi-modal search system 106 (or the multi-modal search database system 116) may receive the merchant-specific product data and/or the merchant-specific product images from the e-commerce system 102, the e-commerce database system 112, the merchant-specific system 104, and/or the merchant-specific database system 114. As such, the multi-modal search system 106 (or the multi-modal search database system 116) and the e-commerce system 102, the e-commerce database system 112, the merchant-specific system 104, and/or the merchant-specific database system 114, respectively, may be communicatively coupled via the network 110.

The system 100 may include or be communicatively coupled to at least one user system 108. User system 108 may be configured to display a plurality of merchant virtual storefronts, a plurality of merchant-specific virtual storefronts, receive single-mode and multi-mode product search queries from the user, and display at least one multi-modal searchable product from a database of multi-modal searchable products that is in accordance with a single-mode product search query or a multi-modal product search query. For instance, the user system 108 may display a merchant virtual storefront (or a merchant-specific virtual storefront), and a user may enter a multi-modal product search query representing a desired product of a merchant into the user system 108. The user system 108 may transmit the multi-modal product search query to the multi-modal search system 106 via the network 110 (e.g., the user system 108 and the multi-modal search system 106 may communicatively couple via the network 110). The multi-modal search system 106 may then select at least one multi-modal searchable product from the database of multi-modal searchable products in accordance with the multi-modal product search query and transmit the at least one multi-modal searchable product to the user system 108 via the network 110. The user system 108 may then display the at least one multi-modal searchable product. The user system 108 may include one or more computing units, such as computing unit 1000 of FIG. 10.

In some embodiments, the e-commerce system 102 includes the functionality of the multi-modal search system 106 (and/or the multi-modal search database system 116), such that the e-commerce system 102 may provide the at least one database of multi-modal searchable products. As such, the e-commerce system 102 may receive the single-mode product search queries or the multi-modal product search queries from the user system 108 via the network 110, respond to a single-mode product search query or a multi-modal product search query by identifying the at least one multi-modal searchable product in accordance with the single-mode product search query or the multi-modal product search query, and transmit the at least one multi-modal searchable product to the user system 108 via the network 110. In some embodiments, the e-commerce database system 112 includes the functionality of the multi-modal search system 106 (and/or the multi-modal search database system 116), such that the e-commerce database system 112 may provide the at least one database of multi-modal searchable products. As such, the e-commerce database system 112 may receive the single-mode product search queries or the multi-modal product search queries from the user system 108 via the network 110, respond to a single-mode product search query or a multi-modal product search query by identifying the at least one multi-modal searchable product in accordance with the single-mode product search query or the multi-modal product search query, and transmit the at least one multi-modal searchable product to the user system 108 via the network 110.

In some embodiments, the merchant-specific system 104 includes the functionality of the multi-modal search system 106 (and/or the multi-modal search database system 116), such that the merchant-specific system 104 may provide the at least one database of multi-modal searchable products. As such, the merchant-specific system 104 may receive the single-mode product search queries or the multi-modal product search queries from the user system 108 via the network 110, respond to a single-mode product search query or a multi-modal product search query by identifying the at least one multi-modal searchable product in accordance with the single-mode product search query or the multi-modal product search query, and transmit the at least one multi-modal searchable product to the user system 108 via the network 110. In some embodiments, the merchant-specific database system 114 includes the functionality of the multi-modal search system 106 (and/or the multi-modal search database system 116), such that the merchant-specific database system 114 may provide the at least one database of multi-modal searchable products. As such, the merchant-specific database system 114 may receive the single-mode product search queries or the multi-modal product search queries from the user system 108 via the network 110, respond to a single-mode product search query or a multi-modal product search query by identifying the at least one multi-modal searchable product in accordance with the single-mode product search query or the multi-modal product search query, and transmit the at least one multi-modal searchable product to the user system 108 via the network 110.

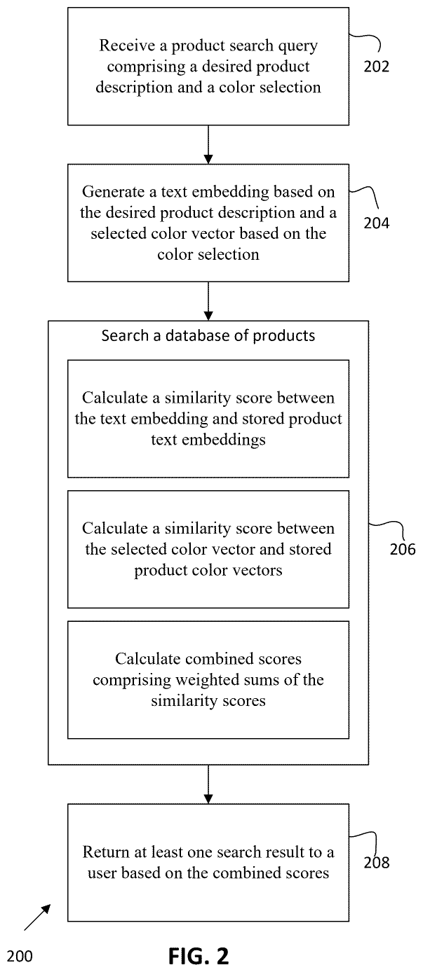

FIG. 2 illustrates an exemplary method 200 for performing a multi-modal product search to identify at least one product (e.g., multi-modal searchable product) in accordance with a product search query (e.g., a multi-modal product search query). The method 200 may be performed using a system configured for multi-modal product searching, such as system 100 of FIG. 1.

In step 202, a product search query may be received, such as by multi-modal search system 106 of FIG. 1. For instance, the product search query may be entered by a user into user system 108, such as by entering the product search query into a product search graphical user interface (GUI) of a merchant-specific virtual storefront, or a merchant virtual storefront, displayed on the user system. The merchant-specific virtual storefront, or the merchant virtual storefront, may be provided by the multi-modal search system 106. As such, the user may submit the product search query, and the user system may transmit the product search query to the multi-modal search system 106 via network 110. In some embodiments, the merchant-specific virtual storefront is provided by merchant-specific system 104 that includes the functionality of the multi-modal search system 106. As such, the user may submit the product search query, and the user system may transmit the product search query to the merchant-specific system 104 that includes the functionality of the multi-modal search system 106 via network 110. In some embodiments, the merchant-specific virtual storefront is provided by merchant-specific system 104. As such, the user system may transmit the product search query to the merchant-specific system 104 via network 110, and the merchant-specific system 104 may transmit the product search query to the multi-modal search system 106 via network 110. In some embodiments, the merchant virtual storefront is provided by e-commerce system 102 that includes the functionality of the multi-modal search system 106. As such, the user may submit the product search query, and the user system may transmit the product search query to the e-commerce system 102 that includes the functionality of the multi-modal search system 106 via network 110. In some embodiments, the merchant virtual storefront is provided by e-commerce system 102. As such the user system may transmit the product search query to the e-commerce system 102 via network 110, and e-commerce system 102 may transmit the product search query to the multi-modal search system 106 via network 110.

The product search query may include a text description of a product entered by the user and a color selection provided by the user. As such, the product search query may be a multi-modal product search query that includes a text-based and color-based product search query. In some embodiments, the product search query includes the desired product description or the color selection. As such, the product search query may be a single-mode product search query as the product search query is a text-based (e.g., desired product description) or a color-based (e.g., color selection) product search query.

The desired product description may include natural language (e.g., natural language sentence(s) with punctuation, natural language sentence(s) without punctuation, natural language partial sentence(s)), keyword(s), or any combination of natural language and keyword(s) that describe the product desired by the user.

The color selection may be at least one dominant color of the desired product selected from a color model. As such, the at least one dominant color, and thus the color selection, may be represented by a plurality of color model values, and each color model value of the plurality of color model values may represent a color property (e.g., hue, saturation, chroma, luminance, intensity, etc.) of the dominant color. For instance, the at least one dominant color, and thus the color selection, may be represented by a plurality of red-green-blue (RGB) color model values, such that a first RGB color model value represents the intensity of red of the at least one dominant color, a second RGB color model value represents the intensity of green of the at least one dominant color, and a third RGB color model value represents the intensity of blue of the at least one dominant color. In some embodiments, the at least one dominant color, and thus the color selection, is represented by a plurality of hue-saturation-value (HSV) color model values, such that a first HSV color model value represents the hue of the at least one dominant color, a second HSV color model value represents the saturation of the at least one dominant color, and a third HSV color model value represents the value of the at least one dominant color. In some embodiments, the at least one dominant color, and thus the color selection, is represented by a plurality of cyan-magenta-yellow (CMY) color model values, a plurality of cyan-magenta-yellow-black (CMYK) color model values, a plurality of hue-saturation-lightness (HSL) color model values, a plurality of hue-saturation-intensity (HSI) color model values, a plurality of International Commission on Illumination (CIE) L*, u*, v* (CIELUV) color model values, a plurality of CIE L*, a*, b* (CIELAB) color model values, a plurality of CIE luminance-chroma-hueᵤᵥ (CIELCHᵤᵥ) color model values, or a plurality of CIE luminance-chroma-hue_{ab} (CIELCH_{ab}) color model values.

In some embodiments, the color selection is at least one dominant color selected from any of the color models described herein and the at least one dominant color is represented by at least one color name (e.g., each dominant color is represented by a color name). As such, the at least one color name may be any name of a color selected from the RGB color model, the CMY color model, the CMYK color model, the HSL color model, the HSV color model, the HSI color model, the CIELUV color model, the CIELAB color model, CIELCHᵤᵥ color model, or the CIELCH_{ab} color model.

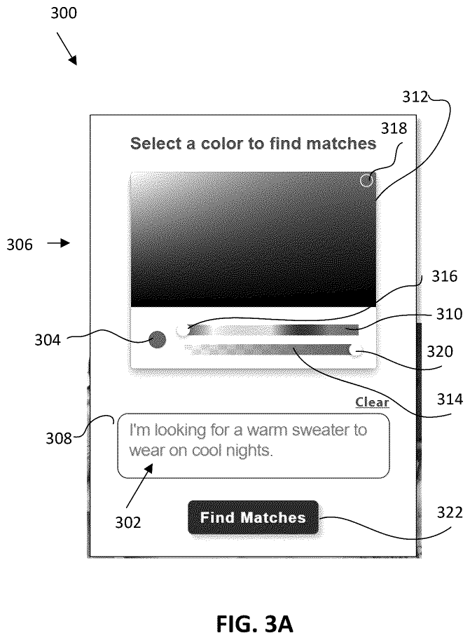

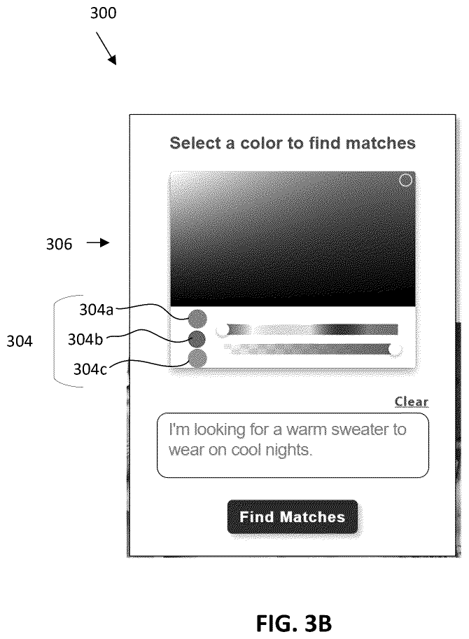

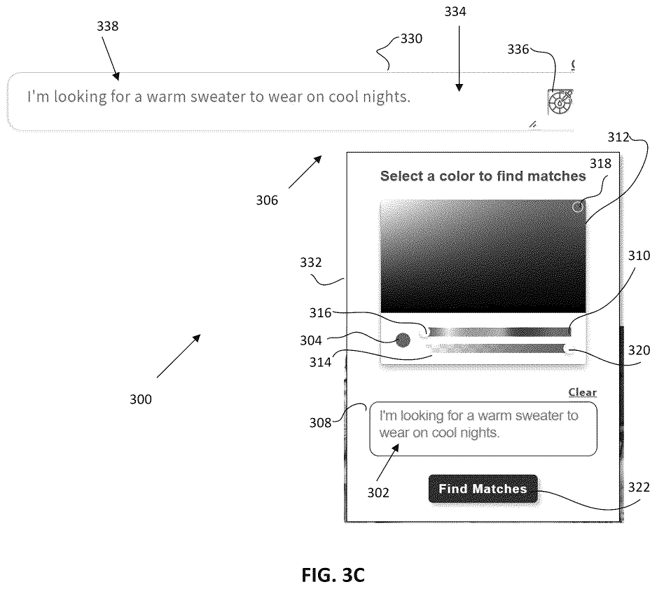

FIG. 3A illustrates an exemplary desired product description 302 and an exemplary color selection 304 of an exemplary product search query 300 entered into an exemplary product search GUI 306. The product search query 300 may be relevant for any product desired by a user, such as any consumer product, any industrial product, and/or any service. The product search GUI 306 may be a portion of a merchant-specific virtual storefront, or a merchant virtual storefront, in which the user can enter the product search query 300. For instance, the user may enter the desired product description 302 of the product search query 300 into a description portion of the product search GUI 306. The user may enter the color selection 304 of the product search query 300 using a color scale 310, a color display 312, and/or an opacity scale 314 of the product search GUI 306. The merchant-specific virtual storefront (or the merchant virtual storefront), and thus the product search GUI 306, may be displayed on a user system that is an exemplary embodiment of user system 108 of FIG. 1.

The desired product description 302 may be any desired product description described herein, such as described in reference to step 202 of method 200 of FIG. 2. As such, the desired product description 302 may include natural language (e.g., natural language sentence(s) with punctuation, natural language sentence(s) without punctuation, natural language partial sentence(s)), keyword(s), or any combination of natural language and keyword(s) that describe the product desired by the user. The desired product description 302 may include reference to one or more product categories, a product brand, a product price, one or more product features, and/or any other concept associated with a desired product.

The product categories may include a product category and/or a product subcategory. The product category may be any word or phrase that broadly categorizes the desired product. For instance, if the desired product is a fashion product, then the product category may be top, bottom, swimwear, shoe, loungewear, jacket, sweater, etc. If the desired product is an appliance, then the product category may be kitchen appliance, office appliance, bathroom appliance, etc. If the desired product is a pet, then the product category may be a type of pet, such as dog, cat, rabbit, hamster, etc., or a pet product, such as dog medicine, cat medicine, cat toy, dog toy, dog bed, cat bed, etc.

The product subcategory may be any word or phrase that categorizes the desired product into a narrower category (e.g., a secondary category). For instance, if the product category is top, then the product subcategory may be blouse, t-shirt, flannel, tank top, etc. If the product category is kitchen appliance, then the product subcategory may be blender, air fryer, microwave, toaster, etc. If the product category is dog toy, then the product subcategory may be chew toy, plush toy, fetch toy, rope toy, interactive puzzle toy, etc. In some embodiments, the desired product description 302 includes the product category and the product subcategory. In some embodiments, the desired product description 302 includes the product category and does not include the product subcategory. In some embodiments, the desired product description 302 includes the product subcategory and does not include the product category.

The product brand may be any brand name of the desired product. For instance, if the desired product is a fashion product, the product brand may be any fashion brand name, such as CHANEL, NIKE, OLD NAVY, etc. If the desired product is a kitchen appliance, then the product brand may be any kitchen appliance brand name, such as KITCHENAID, BOSCH, SAMSUNG, etc.

The product price may be any numeric price of the desired product and/or any currency word, currency phrase, and/or currency symbol of the price of the desired product. For instance, the product price may be a singular numeric price, such as 49.99, 5.00, 5, 100, etc. In some embodiments, the product price is a singular numeric price with a currency symbol, such as $49.99, 5$, $5.00, etc. In some embodiments, the product price is a singular numeric price with a currency word. For instance, the product price may be 49.99 dollars, 5.00 euros, etc. In some embodiments, the product price is a singular numeric price with a currency phrase and/or currency symbol. For instance, the product price may be “less than 50 dollars”, “greater than $ 10”, etc. In some embodiments, the product price is a plurality of numeric values with a currency word, currency phrase, and/or currency symbol. For instance, the product price may be “45-75 dollars”, “$ 45-$75”, “greater than 45 dollars but less than $ 75”, etc. In some embodiments, the product price is any currency word, currency phrase, and/or currency symbol. For instance, the product price may be “$five,” “ten dollars,” “greater than ten dollars,” “less than one hundred dollars,” etc.

The product feature(s) may be any feature(s) describing the structure, appearance, material, or other characteristics that make the desired product distinct. For instance, if the desired product is a fashion product, then the product features may be sleeve length (e.g., short-sleeved, long-sleeved, sleeveless, etc.), neckline (e.g., round neckline, heart neckline, v-neckline, etc.), bottom length (e.g., ankle length, full-length, cropped, mini, etc.), material (e.g., wool, cotton, linen, silk, blends, etc.), fit (e.g., tight, loose, buttoned, flared, etc.), accessories (e.g., buttons, collar, bows, built-in belt, fringe, etc.), pattern (e.g., stripes, spotted, lace, tie-dye, etc.), etc. If the desired product is an appliance, such as a kitchen appliance, then the product features may be power requirements/outputs, temperature (e.g., operating temperature, oven temperature, etc.), material (e.g., ceramic, wood, metal, etc.), accessories (e.g., wired/wireless, electronic display, Wi-Fi-enabled, etc.), etc. In some embodiments, the product features include product gender, product style, and/or product occasion. In some embodiments, the product features include a target age demographic associated with the desired product.

The product gender may be any gender associated with the desired product. For instance, the product gender may be male (or any synonym of male, such as dude, guy, fellow, etc.), female (or any synonym of female, such as lady, woman, girl, etc.), or unisex (or any synonym of unisex, such as androgynous, genderless, etc.). In some embodiments, the product gender is masculine (or any synonym of masculine), feminine (or any synonym of feminine), or unisexual (or any synonym of unisexual).

The product style may be any style associated with the desired product. For instance, if the desired product is a fashion product, then the product style may be a fashion style, such as casual, formal, chic, artsy, boho-chic, bohemian, grunge, minimalist, vintage, etc., or any combination of fashion styles, such as minimalist and vintage, casual and chic, bohemian and artsy and chic, etc.

The product occasion may be any word or phrase describing when or why the desired product would be used, worn, or otherwise interacted with. For instance, if the desired product is a fashion product, the product occasion may be events at which the fashion product could be worn (e.g., wedding, night-out, cocktail party, festival, etc.), weather at which the fashion product could be worn (e.g., rainy, sunny, warm, cold, etc.), a season at which the fashion product could be worn (e.g., fall, spring, summer, fall), a time of day at which the fashion product could be worn (e.g., night/evening, morning, afternoon, mid-day, etc.), etc. In some embodiments, the desired product description 302 includes a plurality of product occasions. For instance, if the desired product is a fashion product, then the desired product description may include a plurality of product occasions describing an event, weather, season, and/or time of day at which the desired fashion product could be worn.

In some embodiments, the desired product description 302 includes a color name of a dominant color selected from any of the color models described herein. For instance, the color name of the dominant color selected from a RGB color model may be “red,” “blue,” “periwinkle,” “magenta,” “chartreuse,” “mint,” “amaranth,” etc. In some embodiments, the desired product description 302 includes a plurality of color names of a plurality of dominant colors selected from any of the color models described herein. If the desired product description 302 includes the color name(s), then the color name(s) may be used as the color selection of the product search query 300. As such, the color selection 304 may be overridden by the color name(s).

It should be understood that the aforementioned examples of the product categories, product brand, product price, and product features of the desired product description 302 are for illustrative purposes and not intended to be limiting.

The color selection 304 may be at least one dominant color of the desired product selected from any color model described herein. As such, the at least one dominant color may be represented by a plurality of color model values, such as described in step 202 of method 200 of FIG. 2. In the exemplary product search query 300, the color selection 304 is a dominant color of the desired product, and the dominant color may be represented by a plurality of color model values. The user may enter the color selection 304 using the color scale 310, the color display 312, and/or the opacity scale 314 of the product search GUI 306. For instance, the user may enter the hue of the color selection 304 via the color scale 310, the tint, tone, and/or shade of the color selection 304 via the color display 312, and/or the opacity of the color selection 304 via the opacity scale 314.

The color scale 310 of the product search GUI 306 may be configured to display a plurality of hues of colors, and the plurality of hues of colors may be from any color model described herein. The user may enter the hue of the color selection 304 by selecting a hue within the color scale 310. When the user selects a hue within the color scale 310, the color selection 304 dynamically updates to match the hue selected by the user. In some embodiments, the user selects the hue of the color selection 304 by dragging or placing a color scale indicator 316 onto a hue of the color scale 310. The color scale indicator 316 may be any size (e.g., such as, larger than the width of the color scale 310, smaller than the width of the color scale 310, the same width as the color scale 310, etc.), any shape (e.g., such as, star, circle, square, rectangle, etc.), color (e.g., such as, white, black, dynamically changing, etc.), and fill (e.g., solid fill, patterned fill, no fill, etc.). In some embodiments, the color scale 310 is configured to alternatively display a plurality of tints of colors from any color model described herein, a plurality of tones of colors from any color model described herein, or a plurality of shades of colors from any color model described herein. In some embodiments, the product search GUI 306 includes a plurality of color scales. For instance, the product search GUI 306 may include a first color scale configured to display a plurality of color hues, a second color scale configured to display a plurality of color tints, a third color scale configured to display a plurality of color tones, and/or a fourth color scale configured to display a plurality of color shades. In such an embodiment, the user may enter the hue and tint of the color selection 304 using the first and second color scales, the hue and tone of the color selection 304 using the first and third color scales, or the hue and shade of the color selection 304 using the first and fourth color scales.

The color display 312 may be configured to display the plurality of color tints, the plurality of color tones, and the plurality of color shades associated with the hue of the color selection 304. The user may enter the tint, tone, or shade of the color selection 304 (e.g., tint, tone, or shade associated with the hue of the color selection 304) by selecting the tint, tone, or shade within the color display 312. When the user selects the tint, tone, or shade within the color display 312, the color selection 304 dynamically updates to match the tint, tone, or shade selected by the user. In some embodiments, the user selects the tint, tone, or shade of the color selection 304 by dragging or placing a color display indicator 318 onto a tint, tone, or shade of the color display 312. The color display indicator 318 may be any shape (e.g., such as, star, circle, square, rectangle, etc.), color (e.g., such as, white, black, dynamically changing, etc.), and fill (e.g., solid fill, patterned fill, no fill, etc.). In some embodiments, the color display indicator 318 is not user-interactable, such that the color display indicator 318 passively appears at the tint, tone, or shade selected by the user. As such, the color display indicator 318 may identify (e.g., mark) the tint, tone, or shade on the color display 312 that the user selected. In some embodiments, the color display 312 is configured to alternatively, or additionally, display the plurality of color hues. As such, the user may enter the hue and tint of the color selection 304, the hue and tone of the color selection 304, or the hue and shade of the color selection 304 using the color display 312.

In some embodiments, the color display 312 is configured to display the plurality of color tints associated with the hue of the color selection 304. As such, the user may select the tint of the color selection 304 using the color display 312. In some embodiments, the color display is configured to display the plurality of color tones associated with the hue of the color selection 304. As such, the user may select the tone of the color selection 304 using the color display 312. In some embodiments, the color display is configured to display the plurality of color shades associated with the hue of the color selection 304. As such, the user may select the shade of the color selection 304 using the color display 312. In some embodiments, the product search GUI 306 includes a plurality of color displays. For instance, the product search GUI 306 may include a first color display configured to display a plurality of color hues, a second color display configured to display a plurality of color tints, a third color display configured to display a plurality of color tones, and/or a fourth color display configured to display a plurality of color shades. In such an embodiment, the user may enter the hue and tint of the color selection 304 via the first and second color displays, respectively, the hue and tone of the color selection 304 via the first and third color displays, respectively, or the hue and shade of the color selection 304 via the first and fourth color displays, respectively.

The opacity scale 314 may be configured to display a plurality of opacities of colors from any color model described herein. For instance, the opacity scale 314 may be configured to display a plurality of opacities associated with the color hue and color tint selected by the user, the color hue and color tone selected by the user, or the color hue and color shade selected by the user. In some embodiments, the opacity scale 314 is configured to display a plurality of opacities associated with the color hue selected by the user.

The user may enter the opacity of the color selection 304 by selecting an opacity within the opacity scale 314. When the user selects the opacity within the opacity scale 314, the color selection 304 may dynamically update to match the opacity selected by the user. In some embodiments, the user selects the opacity of the color selection 304 by dragging or placing an opacity scale indicator 320 onto an opacity within the opacity scale 314. The opacity scale indicator 320 may be any size (e.g., such as, larger than the width of the opacity scale 314, smaller than the width of the opacity scale 314, the same width as the opacity scale 314, etc.), any shape (e.g., such as, star, circle, square, rectangle, etc.), color (e.g., such as, white, black, dynamically changing, etc.), and fill (e.g., solid fill, patterned fill, no fill, etc.). In some embodiments, the product search GUI 306 includes a plurality of opacity scales. For instance, the product search GUI 306 may include a first opacity scale configured to display the plurality of opacities associated with the hue selected by the user and a second opacity scale configured to display the plurality of opacities associated with the tint selected by the user. As such, the user may select the opacity of the color hue and the opacity of the color tint associated with the hue. In some embodiments, the second opacity scale is configured to display the plurality of opacities associated with the tone. As such, the user may select the opacity of the color hue and the opacity of the color tone associated with the hue. In some embodiments, the second opacity scale is configured to display the plurality of opacities associated with the shade. As such, the user may select the opacity of the color hue and the opacity of the color shade associated with the hue.

Such as described herein, the color selection 304 may be at least one dominant color of the desired product selected from any color model described herein. FIG. 3B illustrates color selection 304 that includes a plurality of dominant colors of the desired product, such as a first color 304a, a second color 304b, and a third color 304c, which may be entered by the user using any of the aforementioned (e.g., using the color scale 310, the color display 312, and/or the opacity scale 314 of the product search GUI 306).

Following entering the desired product description 302 into the product search GUI 306 and selecting the color selection 304 with the product search GUI 306, the user may submit the product search query 300. For instance, the user may select a user-selectable icon, such as user-selectable icon 322, and the product search query 300 may be transmitted, such as described in reference to FIG. 1. In some embodiments, the desired product description 302 may be entered into a first product search region of the product search GUI 306, and the color selection 304 may be selected in a second product search region of the product search GUI 306.

FIG. 3C illustrates a first product search region 330 of the product search GUI 306 and a second product search region 332 of the product search GUI 306 that are used to generate and submit the product search query 300. The first product search region 330 may include a description portion 334 at which the user may enter a desired product description 338. The desired product description 338 may be any desired product description described herein, such as desired product description 302 of FIG. 3A. The first product search region 330 may include a user-selectable icon 336 configured to launch the second product search region 332. Such as described herein, the second product search region 332 may include the description portion 308 at which the user may enter the desired product description 302. If the user entered the desired product description 338 in the description portion 334, then the description portion 308 may include the desired product description 338, such that the desired product description 338 is populated into the description portion 308. If the user entered the desired product description 302 in the description portion 308, then the description portion 334 may include the desired product description 302, such that the desired product description 302 is populated into the description portion 334.

Referring back to FIG. 2, in step 204, a text embedding may be generated based on the desired product description, such as desired product description 302 of FIG. 3A, and a selected color vector may be generated based on the color selection, such as color selection 304 of FIG. 3A. The text embedding may be a multi-dimensional vector encoding the desired product description. The multi-dimensional vector encoding the desired product description may have any integer number of dimensions in a range of 50 dimensions to 4,500 dimensions. In some embodiments, the multi-dimensional vector encoding the desired product description has at least 50 dimensions, at least 100 dimensions, at least 200 dimensions, at least 300 dimensions, at least 400 dimensions, at least 500 dimensions, at least 510 dimensions, at least 512 dimensions, at least 514 dimensions, at least 516 dimensions, at least 518 dimensions, at least 520 dimensions, at least 600 dimensions, at least 700 dimensions, at least 720 dimensions, at least 740 dimensions, at least 760 dimensions, at least 762 dimensions, at least 764 dimensions, at least 766 dimensions, at least 768 dimensions, at least 770 dimensions, at least 800 dimensions, at least 900 dimensions, at least 1,000 dimensions, at least 1,020 dimensions, at least 1,022 dimensions, at least 1,024 dimensions, at least 1,026 dimensions, at least 1,028 dimensions, at least 1,500 dimensions, at least 1,530 dimensions, at least 1,532 dimensions, at least 1,534 dimensions, at least 1,536 dimensions, at least 1,538 dimensions, at least 1,540 dimensions, at least 2,000 dimensions, at least 2,040 dimensions, at least 2,042 dimensions, at least 2,044 dimensions, at least 2,046 dimensions, at least 2,048 dimensions, at least 2,050 dimensions, at least 2,500 dimensions, at least 3,000 dimensions, at least 3,500 dimensions, at least 4,000 dimensions, at least 4,090 dimensions, at least 4,092 dimensions, at least 4,094 dimensions, at least 4,096 dimensions, at least 4,098 dimensions, at least 4,100 dimensions, or at least 4,500 dimensions. In some embodiments, the multi-dimensional vector encoding the desired product description has at most 50 dimensions, at most 100 dimensions, at most 200 dimensions, at most 300 dimensions, at most 400 dimensions, at most 500 dimensions, at most 510 dimensions, at most 512 dimensions, at most 514 dimensions, at most 516 dimensions, at most 518 dimensions, at most 520 dimensions, at most 600 dimensions, at most 700 dimensions, at most 720 dimensions, at most 740 dimensions, at most 760 dimensions, at most 762 dimensions, at most 764 dimensions, at most 766 dimensions, at most 768 dimensions, at most 770 dimensions, at most 800 dimensions, at most 900 dimensions, at most 1,000 dimensions, at most 1,020 dimensions, at most 1,022 dimensions, at most 1,024 dimensions, at most 1,026 dimensions, at most 1,028dimensions, at most 1,500 dimensions, at most 1,530 dimensions, at most 1,532 dimensions, at most 1,534 dimensions, at most 1,536 dimensions, at most 1,538 dimensions, at most 1,540dimensions, at most 2,000 dimensions, at most 2,040 dimensions, at most 2,042 dimensions, at most 2,044 dimensions, at most 2,046 dimensions, at most 2,048 dimensions, at most 2,050dimensions, at most 2,500 dimensions, at most 3,000 dimensions, at most 3,500 dimensions, at most 4,000 dimensions, at most 4,090 dimensions, at most 4,092 dimensions, at most 4,094 dimensions, at most 4,096 dimensions, at most 4,098 dimensions, at most 4,100 dimensions, or at most 4,500 dimensions.

In some embodiments, the text embedding is generated by encoding the desired product description into the multi-dimensional vector using machine learning, such as recurrent neural network models, long short-term memory network models, or transformer models (e.g., such as, Bidirectional Encoder Representations from Transformers (BERT) or sentence-BERT (SBERT)). The encoding of the desired product description into the multi-dimensional vector may preserve the contextual meaning of the desired product description.

In some embodiments, prior to generating the text embedding, the desired product description is processed by a language model (LM), such as a large language model (LLM). For instance, the multi-modal search system 106 may provide the desired product description of the product search query received in step 202 to an LM hosted internally by the multi-modal search system 106, and the internally hosted LM may then process the desired product description and return its outputs to the multi-modal search system 106. In some embodiments, multi-modal search system 106 transmits the desired product description to an externally hosted LM via network 110. For instance, the LM may be hosted by a cloud computing platform. The externally hosted LM may then process the desired product description and transmit its outputs to multi-modal search system 106 via network 110.

The LM (e.g., internally hosted LM or externally hosted LM) may process the desired product description by determining whether the desired product description includes one or more product categories, a product brand, a product price, and/or one or more product features, such as product categories, product brand, product price, and product features described in reference to desired product description 302 of FIG. 3A. If the desired product description includes one or more product categories, a product brand, a product price, and/or one or more product features, the LM may identify the one or more product categories, product brand, product price, and/or one or more product features included in the desired product description. As such, the LM outputs may include the desired product description and the identified one or more product categories, product brand, product price, and/or one or more product features. The identified one or more product categories, product brand, product price, and/or one or more product features may be stored for later use. The desired product description may then be used to generate the text embedding.

In some embodiments, if the desired product description includes a color name, or color names, then the LM may identify the color name. As such, the LM outputs may include the desired product description and the identified color name. The identified color name may be stored for later use. The desired product description may then be used to generate the text embedding. In some embodiments, the color name of the desired product description may be encoded in the selected color vector.

The selected color vector encoding the color selection of the product search query (or encoding the color name of the desired product description of the product search query) may be a vector that preserves the color properties of the color selection. The selected color vector may have any integer number of dimensions in a range of 3 dimensions to 15 dimensions. In some embodiments, the selected color vector has at least 3 dimensions, at least 4 dimensions, at least 5 dimensions, at least 6 dimensions, at least 7 dimensions, at least 8 dimensions, at least 9 dimensions, at least 10 dimensions, at least 11 dimensions, at least 12 dimensions, at least 13 dimensions, at least 14 dimensions, or at least 15 dimensions. In some embodiments, the selected color vector has at most 3 dimensions, at most 4 dimensions, at most 5 dimensions, at most 6 dimensions, at most 7 dimensions, at most 8 dimensions, at most 9 dimensions, at most 10 dimensions, at most 11 dimensions, at most 12 dimensions, at most 13 dimensions, at most 14 dimensions, or at most 15 dimensions.

In some embodiments, the color selection is processed prior to being encoded into the selected color vector. For instance, the color selection may be converted from a plurality of first color model values to a plurality of second color model values. The plurality of first color model values may be the plurality of color model values representing the at least one dominant color of the color selection received in step 202. The plurality of second color model values may be a plurality of values of any color model except the color model of the plurality of first color model values. For instance, if the color selection received in step 202 is at least one dominant color represented by a plurality of RGB color model values, then a plurality of second color model values may be a plurality of CMY color model values, a plurality of CMYK color model values, a plurality of HSL color model values, a plurality of HSV color model values, a plurality of HSI color model values, a plurality of CIELUV color model values, a plurality of CIELAB color model values, a plurality of CIELCHᵤᵥ color model values, or a plurality of CIELCH_{ab} color model values. The color selection represented by the plurality of second color model values may then be encoded into the selected color vector.

In some embodiments, the color selection is converted from the plurality of first color model values to a plurality of HSV color model values. The color selection represented by the plurality of HSV color model values may then be encoded into the selected color vector. For instance, the plurality of HSV color model values may be encoded into a four-dimensional (4D) selected color vector. A first dimension of the selected color vector may be encoded from a first HSV color model value representing the hue of the color selection by calculating the cosine of the hue (e.g., cos(hue)). A second dimension of the selected color vector may be encoded also from the first HSV color model value representing the hue of the color selection by calculating the sine of the hue (e.g., sin(hue)). A third dimension of the selected color vector may be encoded from a second HSV color model value representing the saturation, or a normalized saturation, of the color selection. A fourth dimension of the selected color vector may be encoded from a third HSV color model value representing the value, or a normalized value, of the color selection.

In some embodiments, the color selection is converted from the color name to a plurality of color model values. For instance, such as described herein, the LM may identify the color name from the desired production description and output the identified color name. The color name may be converted to a plurality of color model values that represent the color name. For instance, if the color name is “red,” then “red” may be converted to a plurality of RGB color model values that represent “red,” such as a first RGB color model value of 255 (e.g., representing the intensity of red of the color name “red”), a second RGB color model value of 0 (e.g., representing the intensity of green of the color name “red”), and a third RGB color model value of 0 (e.g., representing the intensity of blue of the color name “red”). The color name may be converted to a plurality of values of any color model described herein. For instance, the color name may be converted to a plurality of CMY color model values that represent the color name, a plurality of CMYK color model values that represent the color name, a plurality of HSL color model values that represent the color name, a plurality of HSV color model values that represent the color name, a plurality of HSI color model values that represent the color name, a plurality of CIELUV color model values that represent the color name, a plurality of CIELAB color model values that represent the color name a plurality of CIELCHᵤᵥ color model values that represent the color name, or a plurality of CIELCH_{ab} color model values that represent the color name.

In some embodiments, the plurality of color model values representing the color name may be encoded into the selected color vector. In some embodiments, if the plurality of color model values is not a plurality of HSV color model values representing the color name, the plurality of color model values is converted to a plurality of HSV color model values. The color selection represented by the color name represented by the plurality of HSV color model values may then be encoded into the selected color vector.

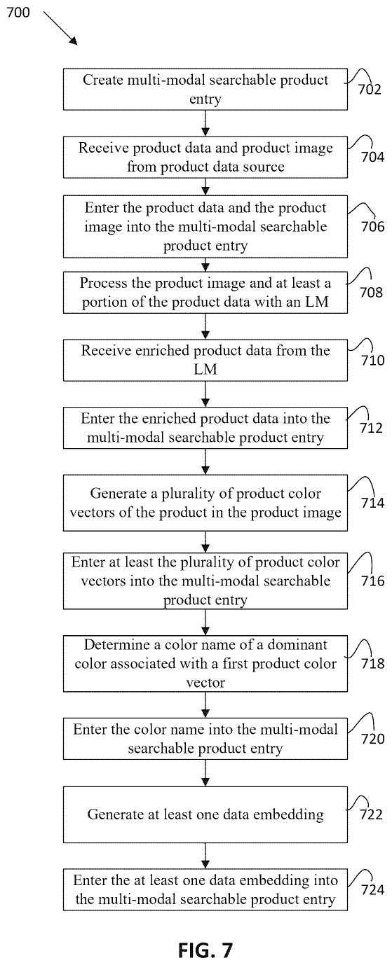

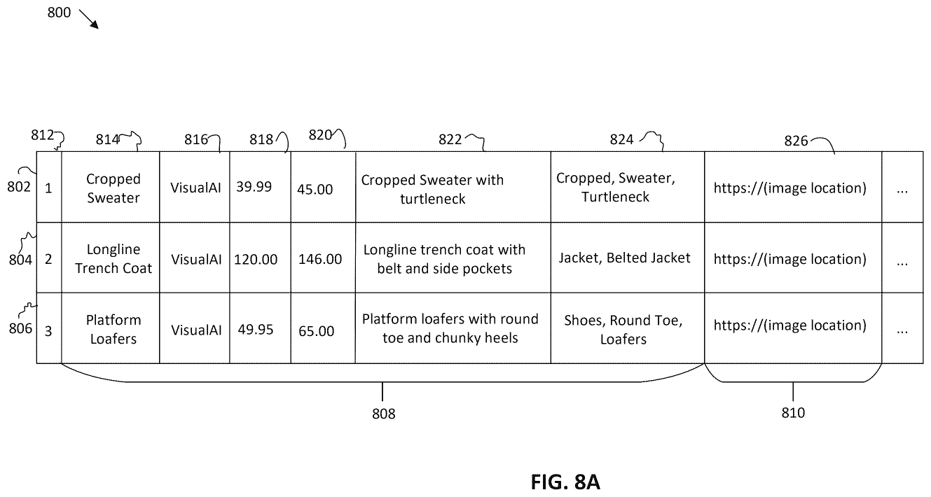

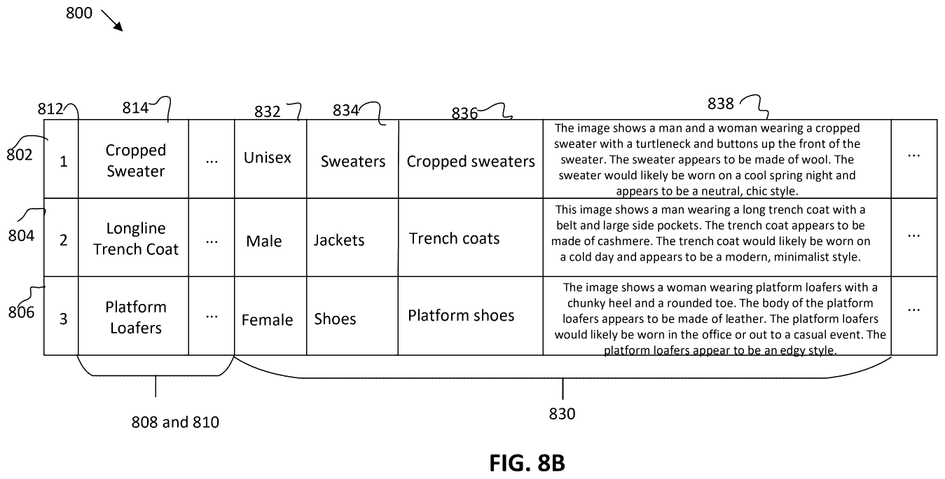

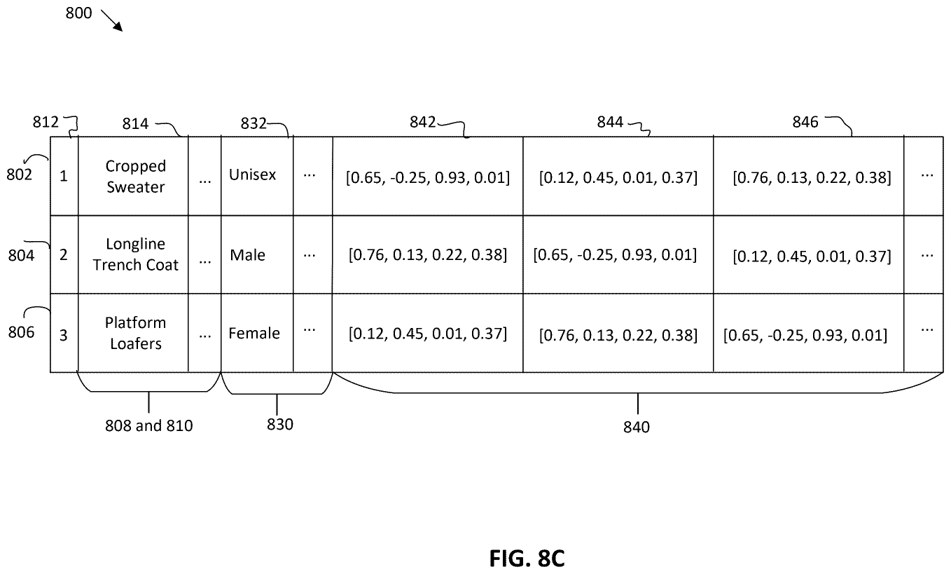

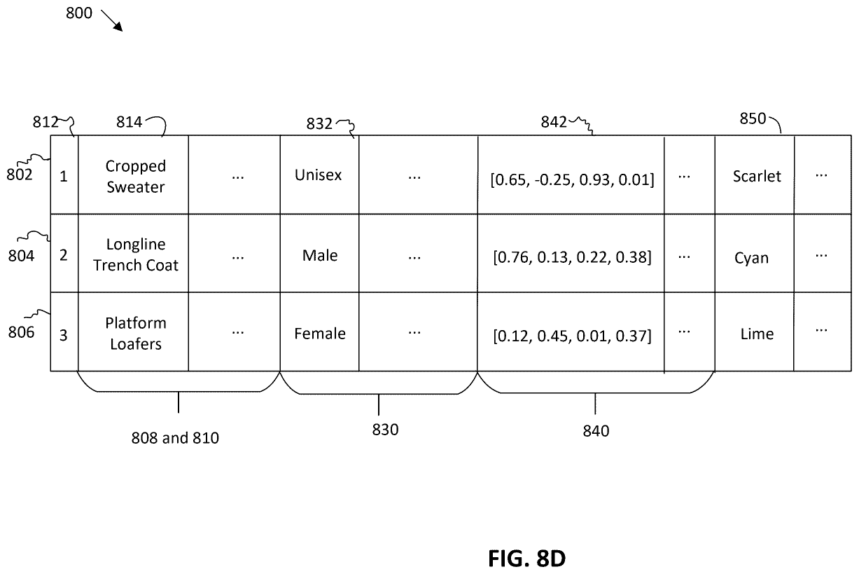

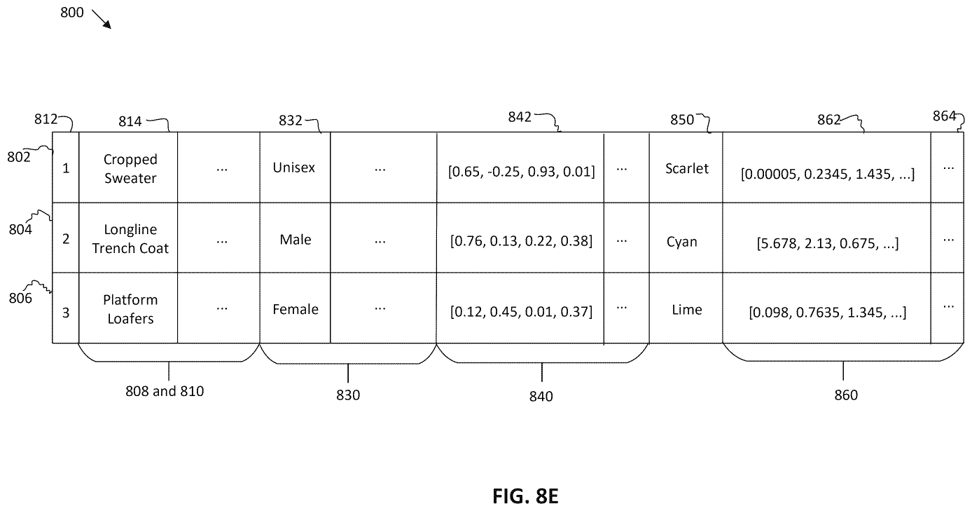

In step 206, a database of products (e.g., database of multi-modal searchable products) may be searched based on the text embedding and the selected color vector (or the at least one selected color vector). Each product of the database of products may have a stored product text embedding and/or a plurality of stored product color vectors. Such as described in method 700 of FIG. 7, the stored product text embedding may be generated for each product by encoding data of each product (e.g., product data 808 of FIGS. 8A-8E), data of each product enriched by an LM (e.g., enriched product data 830 of FIGS. 8A-8E), and/or the color name (e.g., color name 850 of FIGS. 8A-8E) of a dominant color of each product. In some embodiments, each product of the database of products has a plurality of stored product text embeddings, such as described in step 724 of method 700 of FIG. 7. For instance, each product of the database may have a first stored product text embedding encoding the data and the color name of each product. Each product of the database may have a second stored product text embedding encoding the data of each product enriched by the LM. Each product of the database may have a third stored product text embedding encoding the data, the color name, and the enriched data of each product.

The at least one stored product color vector may represent at least one dominant color of the product (e.g., each stored product color vector represents a dominant color of the product). For instance, each product may have an integer number of stored product color vectors in a range of 1 to 10. In some embodiments, each product has at least 1 stored product color vector, at least 2 stored product color vectors, at least 3 stored product color vectors, at least 4 stored product color vectors, at least 5 stored product color vectors, at least 6 stored product color vectors, at least 7 stored product color vectors, at least 8 stored product color vectors, at least 9 stored product color vectors, or at least 10 stored product color vectors. In some embodiments, each product has at most 1 stored product color vectors, at most 2 stored product color vectors, at most 3 stored product color vectors, at most 4 stored product color vectors, at most 5 stored product color vectors, at most 6 stored product color vectors, at most 7 stored product color vectors, at most 8 stored product color vectors, at most 9 stored product color vectors, or at most 10 stored product color vectors.

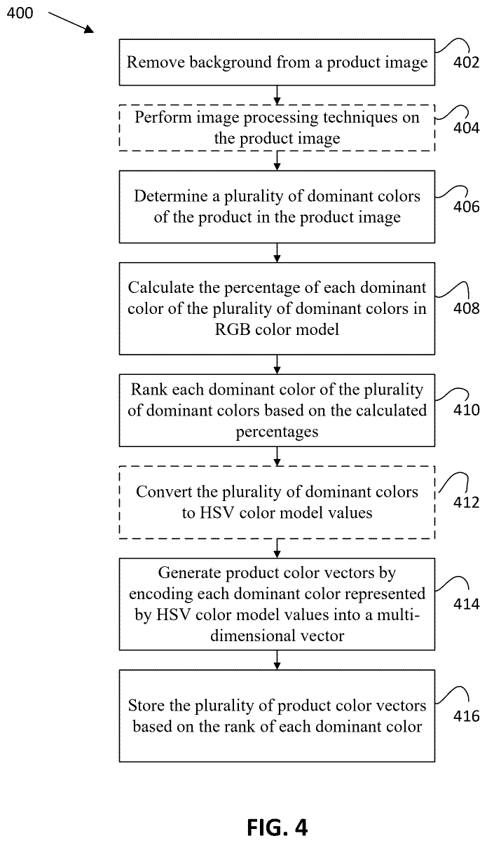

FIG. 4 illustrates a method 400 for generating a plurality of stored product color vectors for a product of a database of products (e.g., such as, a database of multi-modal searchable products). The method 400 may be performed by a multi-modal search system, such as multi-modal search system 106 of FIG. 1. Method 400 may be performed for images of a plurality of products. A given product image may be obtained from an e-commerce system, such as e-commerce system 102 of FIG. 1, via a network, such as network 110 of FIG. 1, that communicatively couples the multi-modal search system to the e-commerce system. In some embodiments, the product image is obtained from an e-commerce database system, such as e-commerce database system 112, via the network that communicatively couples the multi-modal search system to the e-commerce database system. In some embodiments, the product image is obtained from a merchant-specific system, such as merchant-specific system 104 of FIG. 1, via the network that communicatively couples the multi-modal search system to the merchant-specific system. In some embodiments, the product image is obtained from a merchant-specific database system, such as merchant-specific database system 114, via the network that communicatively couples the muti-modal search system to the merchant-specific database system.

In step 402, a background may be removed from a product image. The background of the product image may be any portion of the product image that does not illustrate the product. The background of the product image may be removed or otherwise masked by a machine learning model trained to remove or otherwise mask an image background. The machine learning model may be internally hosted by the multi-modal search system. As such, the multi-modal search system may provide the product image to the internally hosted machine learning model and may receive a product image without a background (e.g., a product image with the background removed or otherwise masked). In some embodiments, the machine learning model is externally hosted, such as by a cloud computing platform. As such, the multi-modal search system may transmit the product image to the externally hosted machine learning model via the network and may receive the product image without a background from the externally hosted machine learning model via the network. The machine learning model may be CANVA, PHOTOSCISSORS, PIXLR, ADOBE SPARK, PYTHON PILLOW, OPENCV, REMBG, etc. The background may be removed so that the background does not influence a determination of a plurality of dominant colors of the product in the product image.

In step 404, at least one image processing technique may be performed on the product image to minimize or eliminate the influence of non-product features on the determination of the plurality of dominant colors of the product. For instance, the at least one image processing technique may be masking skin from the product image, in which pre-defined skin colors are minimized or eliminated from the product image, such that the pre-defined skin colors minimally, or do not, influence the determination of the plurality of dominant colors of the product. As such, if the influence of skin colors is minimized or eliminated, then the plurality of dominant colors may not include the pre-defined skin colors. The pre-defined skin colors may be color names and/or color model values, such as any color model value described herein. Minimizing or eliminating the influence of pre-defined skin colors may be performed if the product image includes a model wearing, showcasing, or otherwise displaying the product. In some embodiments, the at least one image processing technique is image cropping, in which the product image is cropped via conventional image cropping software to minimize or eliminate the non-product features, such that the minimized or eliminated non-product features do not influence the determination of the plurality of dominant colors of the product. For instance, cropping the product image may minimize or eliminate the model wearing, showcasing, or otherwise displaying the product, such that the model does not influence the determination of the plurality of dominant colors of the product. In some embodiments, step 404 is not performed, such that the product image does not undergo at least one image processing technique. In some embodiments, step 404 is performed before step 402.

In step 406, at least one dominant color of the product in the product image (or the cropped product image) is determined. As used herein, a dominant color is a color that is prevalent in the product as captured in the image. A given product may have multiple dominant colors. As such, as used herein “a dominant color” can be a most dominant color, a second most dominant color, and third most dominant color, etc. The plurality of dominant colors may be determined using machine learning. For instance, the plurality of dominant colors may be determined using machine learning clustering, such as centroid-based clustering (e.g., k-means clustering), density-based clustering, or distribution-based clustering. The machine learning clustering may receive the product image, or the cropped product image, and determine clusters of values of any color model described herein based on the received product image, or the received cropped product image. For instance, the machine learning clustering may determine clusters of pixels of the product image, or the cropped product image, that are associated with a plurality of color model values (e.g., each pixel may be associated with a plurality of color model values). The machine learning clustering may then output the location of the clusters or the centroid of the clusters, such that each location or each centroid of the clusters is a plurality of color model values representing a dominant color of the product of the product image.

Each dominant color of the plurality of dominant colors may be a plurality of color model values, and the color model may be any color model described herein. In some embodiments, each dominant color of the plurality of dominant colors is a color name. In some embodiments, the plurality of dominant colors may be a plurality of color model values from a plurality of color models. For instance, a first dominant color may be a plurality of color model values from a first color model, a second dominant color may be a plurality of color model values from a second color model, and a third dominant color may be a plurality of color model values from a third color model.

The plurality of dominant colors determined for the product may be any integer number of dominant colors in a range of 1 dominant color to 10 dominant colors. In some embodiments, the number of dominant colors determined for the product is at least 1 dominant color, at least 2 dominant colors, at least 3 dominant colors, at least 4 dominant colors, at least 5 dominant colors, at least 6 dominant colors, at least 7 dominant colors, at least 8 dominant colors, at least 9 dominant colors, or at least 10 dominant colors. In some embodiments, the number of dominant colors determined for the product is 1 dominant color, at most 2 dominant colors, at most 3 dominant colors, at most 4 dominant colors, at most 5 dominant colors, at most 6 dominant colors, at most 7 dominant colors, at most 8 dominant colors, at most 9 dominant colors, or at most 10 dominant colors.

In step 408, a percentage of each dominant color of the plurality of dominant colors may be determined. The percentage of each dominant color may represent the amount that each dominant color represents the color of the product. The percentage of each dominant color may be determined using the machine learning clustering. For instance, the percentage of each dominant color may be determined by summing the number of points, pixels, indexes, etc. in each cluster representing each dominant color that was identified using the machine learning clustering, dividing by the total number of points, pixels, indexes, etc. in all clusters identified using the machine learning cluster, and multiplying by 100. In some embodiments, the calculated percentages may be stored in a product entry (e.g., multi-modal searchable product entry), such as described in method 700 of FIG. 7.

In step 410, each dominant color of the plurality of dominant colors may be ranked based on the calculated percentages. The ranking of the plurality of dominant colors may represent the order for which each dominant color represents the color of the product. For instance, the dominant color ranked as a first ranking has a large calculated percentage, and thus largely represents the color of the product. A dominant color ranked as a last ranking has a small calculated percentage, and thus minimally represents the color of the product.

In step 412, each dominant color may be converted to a plurality of HSV color model values, such that each dominant color is represented by a first HSV color value representing the hue of a dominant color, a second HSV color value representing the saturation of a dominant color, and a third HSV color value representing the value of a dominant color. If each dominant color is already represented by the plurality of HSV color model values, then step 412 may not be performed. In some embodiments, the plurality of HSV color model values for each dominant color may be stored in the product database structure based on the ranking determined in step 410. For instance, a first HSV color model value entry of the product database structure may be the plurality of HSV color values representing the first ranked dominant color and a last HSV color model value entry of the product database structure may be the plurality of HSV color values representing the last ranked dominant color.

In step 414, a product color vector may be generated for each dominant color represented by the plurality of HSV color model values. The product color vector for each dominant color may be generated by encoding the plurality of HSV color model values into a multi-dimensional vector, such as a 4D vector. For instance, the first HSV color model value may be encoded into a first dimension of the 4D vector by calculating the cosine of the hue and a second dimension of the 4D vector by calculating the sine of the hue. The second HSV color model value may be encoded into a third dimension of the 4D vector. In some embodiments, the second HSV color model value is normalized and then encoded into the third dimension of the 4D vector. The second HSV color model value may be normalized so that the third dimension of the 4D vector is of comparable magnitude to the first and second dimension of the 4D vector. The third HSV color model value may be encoded into a fourth dimension of the 4D vector. In some embodiments, the third HSV color model value is normalized and then encoded into the fourth dimension of the 4D vector. The third HSV color model value may be normalized so that the fourth dimension of the 4D vector is of comparable magnitude to the first and second dimension of the 4D vector. As such, the product color vector for each dominant color may be the 4D vector, in which the first element and the second element encode the hue of a dominant color, the third element encodes the saturation, or normalized saturation, of a dominant color, and the fourth element encodes the value, or normalized value, of a dominant color. In some embodiments, a color selection of a product search query from a user, such as color selection 304 of product search query 300 of FIG. 3A, is generated according to step 414 (e.g., by encoding a plurality of HSV color model values into a multi-dimensional vector). In some embodiments, the product color vector is generated akin to the generation of a selected color vector representing a color selection, such as described in step 204 of method 200 of FIG. 2.

In step 416, the product color vector for each dominant color may be stored based on the ranking determined in step 410. For instance, the product color vectors may be stored in the product entry (e.g., multi-modal searchable product entry, such as described in method 700 of FIG. 7) from the first ranking to the last ranking, such that a first product color vector of the product entry is the first ranked dominant color and a last product color vector of the product entry is the last ranked dominant color.

Referring back to step 206 of FIG. 2, the database of products may be searched to determine at least one product of the database of products with the stored product text embedding and the at least one stored product color vector similar to the text embedding and the selected color vector (or the at least one selected color vector), respectively. As such, the database of products may be searched to determine the at least one product of the database of products that is relevant to the product search query based on the stored product text embedding and the at least one stored product vector of the product and the text embedding and the selected color vector(s) of the product search query. For instance, the at least one product of the database of products may be determined by calculating a weighted sum of a first similarity score between the text embedding and the stored product text embedding and a second similarity score between the selected color vector and the at least one stored product color vector of products of the database of products.

The first similarity score may be determined via a first vector similarity search, in which a similarity score between the text embedding and the stored product text embedding is determined by calculating at least one vector distance metric between the text embedding and the stored product text embedding. For instance, the first similarity score may be determined by calculating a cosine distance between the text embedding and the stored product text embedding, by calculating a Euclidean distance between the text embedding and the store product text embedding, and/or a Jaccard distance between the text embedding and the stored product text embedding for each product of the database of products. In some embodiments, the first similarity score may be determined for each product by calculating the at least one vector distance metric between the text embedding and a stored product text embedding of the plurality of stored product text embeddings. For instance, the first similarity score may be determined for each product by calculating the at least one vector distance between text embedding and the first stored product text embedding. In some embodiments, the first similarity score may be determined for each product by calculating the at least one vector distance between the text embedding and the second stored product text embedding. In some embodiments, the first similarity score may be determined for each product by calculating the at least one vector distance between the text embedding and the third stored product text embedding. In some embodiments, the first similarity score may be determined for each product by calculating a weighted sum of the at least one vector distance between the text embedding and the first stored product text embedding, the at least one vector distance between the text embedding and the second stored product text embedding, and/or the at least one vector distance between the text embedding and the third stored product text embedding.

The second similarity score may be determined via a second vector similarity search, in which a similarity score between the selected color vector and the at least one stored product color vector is determined by calculating at least one vector distance metric between the selected color vector and each stored product color vector. For instance, the second similarity score may be determined by calculating a cosine distance between the selected color vector and the at least one stored product color vector, by calculating a Euclidean distance between the selected color vector and the at least one stored product color vector, and/or a Jaccard distance between the selected color vector and the at least one stored product color vector for each product of the database of products. Such as described in step 416 of method 400 of FIG. 4, product color vectors are stored for each product in a product database structure based on a ranking of dominant colors of a product in a product image. As such, the second similarity score may be determined based on the ranking associated with the stored product color vectors. For instance, the second similarity score may be determined by calculating the at least one vector distance metric between the selected color vector and a first stored product color vector, such that the first stored product color vector is associated with a first ranking dominant color, such as described in method 400 of FIG. 4. In some embodiments, the second similarity score may be determined by calculating the at least one vector distance metric between the selected color vector and a portion of the total number of stored product color vectors. For instance, a first vector distance metric between the selected color vector and the first stored product color vector (e.g., representing the first ranking dominant color) may be calculated and a second vector distance metric between the selected color vector and the second stored product color vector (e.g., representing the second ranking dominant color) may be calculated. The second similarity score may then be determined using a weighted sum of the first vector distance metric and the second vector distance metric. In some embodiments, the second similarity score may be determined by calculating the at least one vector distance metric between the selected color vector and all stored product color vectors. For instance, if a given product has three stored product color vectors, then the first vector distance metric may be calculated between the selected color vector and the first stored product color vector, the second vector distance metric may be calculated between the selected color vector and the second stored product color vector, and a third vector distance metric may be calculated between the selected color vector and the third stored product color vector. The second similarity score may then be determined by calculating a weighted sum of the first, second, and third vector distance metrics.

A combined score for each product may then be calculated as a weighted sum of the first similarity score and the second similarity score. For instance, the first similarity score for each product may be weighted with a first weight and the second similarity score for each product may be weighted with a second weight. In some embodiments, the first similarity score is weighted more than the second similarity score, such that the first weight is larger than the second weight. For instance, the first similarity score may be weighted more to prioritize the at least one product being more similar to the text embedding (e.g., the product description). In some embodiments, the second similarity score may be weighted more (e.g., the second weight is larger than the first weight) to prioritize the at least one product being more similar to the selected color vector (e.g., the color selection). In some embodiments, the first similarity score and the second similarity score are weighted equally (e.g., the first weight and the second weight are equal) to prioritize the at least one product being equally similar to the text embedding (e.g., the product description) and the selected color vector (e.g., the color selection).

The products may then be ranked based on the combined score of the products. For instance, the products may be ranked from smallest combined score to largest combined score, such that a product with a large combined score is more similar to the product search query than a product with a small combined score. As such, a product with the largest combined score is the most similar to the product search query, and a product with the smallest combined score is the least similar to the product search query. In some embodiments, the products are ranked from largest combined score to smallest combined score, such that a product with a small combined score is more similar to the product search query than a product with a large combined score.

In some embodiments, the products may be ranked based on the first similarity. For instance, the products may be ranked from the largest first similarity score to the smallest first similarity score, such that a product with a large first similarity score is more similar to the product search query than a product with a small first similarity score. In some embodiments, the products are ranked from the smallest first similarity score to the largest first similarity score, such that a product with a small first similarity score is more similar to the product search query than a product with a large first similarity score. In such embodiments, the second similarity score and/or the combined score may not be determined. In some embodiments, the products may be ranked based on the second similarity. For instance, the products may be ranked from the largest second similarity score to the smallest second similarity score, such that a product with a large second similarity score is more similar to the product search query than a product with a small second similarity score. In some embodiments, the products are ranked from the smallest second similarity score to the largest second similarity score, such that a product with a small second similarity score is more similar to the product search query than a product with a large second similarity score. In such embodiments, the first similarity score and/or the combined score may not be determined.

In some embodiments, the products of the database may be filtered based on the identified product categories, product brand, product price, and/or product features of the desired product description prior to searching the database of products (e.g., prior to calculating the first similarity score and/or the second similarity score). For instance, each product of the database may be filtered based on whether each product is associated with product data and/or enriched product data satisfying the identified product categories, product brand, product price, and/or product features. If a product is not associated with product data and/or enriched product data matching the identified product categories, product brand, product price, and/or product features, then the product may not be used in searching the database of products (e.g., may not be used in calculating the first similarity score and/or the second similarity score). If a product is associated with product data and/or enriched product data matching the identified product categories, product brand, product price, and/or product features, then the product may be used in searching the database of products (e.g., may be used in calculating the first similarity score and/or the second similarity score).

In step 208, at least one search result may be returned to a user based on the combined scores. The at least one search result may be the at least one product with the stored product text embedding and the at least one stored product color vector similar to the text embedding and the selected color vector (or the at least one selected color vector), respectively. For instance, the at least one search result may be at least one product with a largest combined score or a smallest combined score, depending on the type of similar score used. In some embodiments, the at least one search result may be any integer number of products. The at least one search result may be a predefined number of search results (e.g., the top 100 search results based on similarity score). The at least one search result may be the products that have similarity scores that meet a predefined threshold. The at least one search results may be in a range of 1 product with the largest combined score (or smallest combined score, depending on the type of similarity score used) to 100 products with large (or small) combined scores. In some embodiments, the at least one search result may be at least 1 product with a large (or small) combined score, at least 5 products with a large (or small) combined score, at least 10 products with a large (or small) combined score, at least 20 products with a large (or small) combined score, at least 30 products with a large (or small) combined score, at least 40 products with a large (or small) combined score, at least 50 products with a large (or small) combined score, at least 60 products with a large (or small) combined score, at least 70 products with a large (or small) combined score, at least 80 products with a large (or small) combined score, at least 90 products with a large (or small) combined score, or at least 100 products with a large (or small) combined score. In some embodiments, the at least one search result may be at most 1 product with the largest (or smallest) combined score, at most 5 products with a large (or small) combined score, at most 10 products with a large (or small) combined score, at most 20 products with a large (or small) combined score, at most 30 products with a large (or small) combined score, at most 40 products with a large (or small) combined score, at most 50 products with a large (or small) combined score, at most 60 products with a large (or small) combined score, at most 70 products with a large (or small) combined score, at most 80 products with a large (or small) combined score, at most 90 products with a large (or small) combined score, or at most 100 products with a large (or small) combined score.

The at least one search result may be organized on the user system based on the combined score associated with each search result. For instance, the at least one search result may be organized sequentially from a search result associated with the largest combined score to a search result associated with the smallest combined score. As such, a first search result of the at least one search result may be associated with the largest combined score and a last search result may be associated with the smallest combined score. In some embodiments, the at least one search result may be organized sequentially from a search result associated with the smallest combined score to a search result associated with the largest combined score. In some embodiments, the at least one search result may be returned to the user based on the first similarity score. For instance, the at least one search result may be any integer number of products with large first similarities in a range of 1 product with the largest first similarity score to 100 products with large first similarities. As such, the at least one search result may be organized on the user system based on the first similarity score associated with each search result. In some embodiments, the at least one search result is any integer number of products with small first similarities in a range of 1 product with the smallest first similarity score to 100 products with small first similarities. In some embodiments, the at least one search result may be returned to the user based on the second similarity score. For instance, the at least one search result may be any integer number of products with large second similarities in a range of 1 product with the largest second similarity score to 100 products with large second similarities. As such, the at least one search result may be organized on the user system based on the second similarity score associated with each search result. In some embodiments, the at least one search result is any integer number of products with small second similarities in a range of 1 product with the smallest second similarity score to 100 products with small second similarities

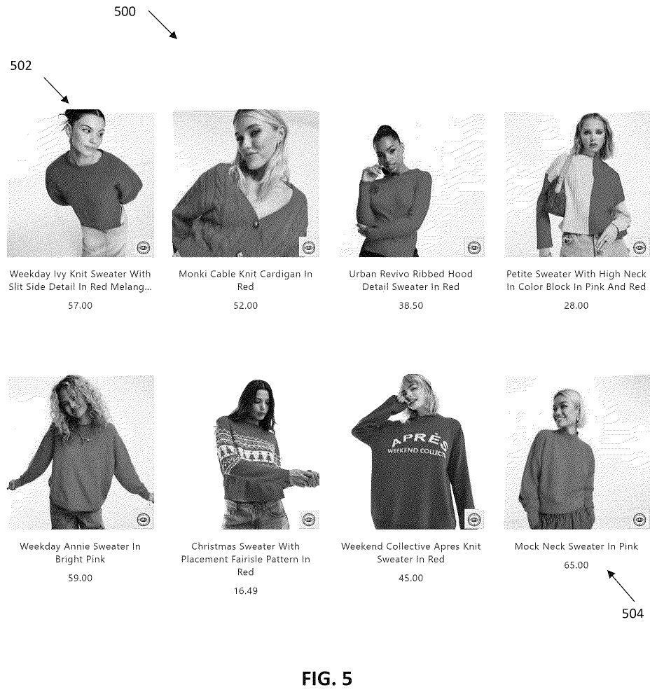

FIG. 5 illustrates exemplary search results 500 for an exemplary product search query. The exemplary product search query may be product search query 300 of FIG. 3A and FIG. 3C. The exemplary search results 500 may be displayed on a user system, such as user system 108 of FIG. 1. The search results 500 may be organized on the user system based on a similarity score of each product of each search result to the product search query. For instance, the search results 500 may be organized on the user system based on a combined score of each product of each search result, a first similarity score of each product of each search result, or a second similarity score of each product of each search result, such as described in reference to step 208 of method 200 of FIG. 2. As such, in some embodiments and depending on the type of similar score used, a first search result 502 is associated with the largest combined score, the largest first similarity score, or the largest second similarity score. In some embodiments and depending on the type of similar score used, the first search result 502 is associated with the smallest combined score, the smallest first similarity score, or the smallest second similarity score. A last search result 504, in some embodiments and depending on the type of similar score used, is associated with the smallest combined score, the smallest first similarity score, or the smallest second similarity score, which may be the smallest combined score, first similarity score, or second similarity score of the search results returned to a user, such as the search result(s) returned to a user in step 408 of method 400 of FIG. 4. In some embodiments and depending on the type of similar score used, the last search result 504 is associated with the largest combined score, the largest first similarity score, or the largest second similarity score, which may be the largest combined score, first similarity score, or second similarity score of the search results returned to a user, such as the search result(s) returned to a user in step 408 of method 400 of FIG. 4

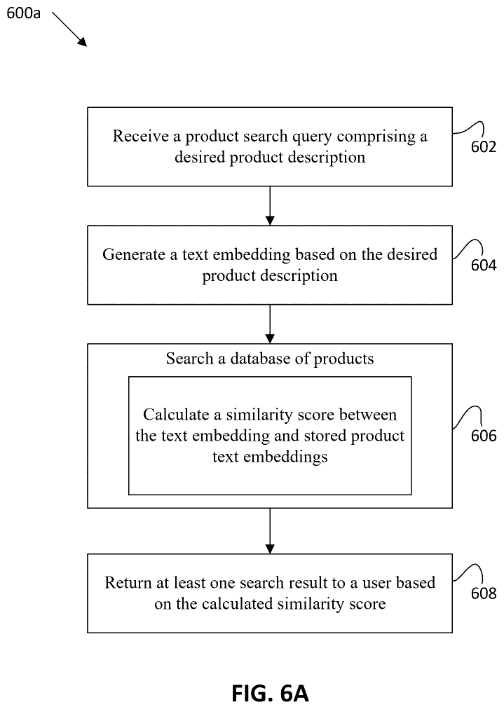

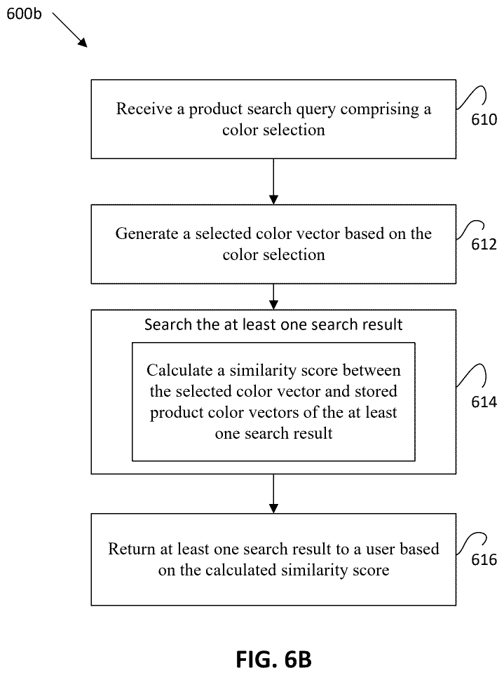

FIG. 6A illustrates an exemplary method 600a for performing a first product search using a first product search query that includes a desired product description. The desired product description may be any desired product description described herein, such as desired product description 302 of FIGS. 3A and 3B. The method 600 may be performed by a system configured for multi-modal product searching, such as system 100 of FIG. 1.

In step 602, the first product search query may be received. The first product search query may be received by a multi-modal search system, such as multi-modal search system 106 of FIG. 1, configured to identify at least one product from a multi-modal searchable database that is in accordance with the first product search query. For instance, the first product search query may be entered by a user into a product search graphical user interface (GUI) of a merchant-specific virtual storefront (e.g., online store) displayed on a user system, such as user system 108 of FIG. 1. The product search GUI may be any product search GUI described herein, such as product search GUI 306 of FIG. 3A, first product search region 330 of FIG. 3C, or second product search region 332 of FIG. 3C. The user may submit the product search query on the user system, and the user system may transmit the product search query to the multi-modal search system via a network, such as network 110 of FIG. 1. In some embodiments, the user system may transmit the product search query to an e-commerce system, such as e-commerce system 102 of FIG. 1. In some embodiments, the user system may transmit the product search query to a merchant-specific system, such as merchant-specific system 104 of FIG. 1.

In step 604, a text embedding may be generated based on the desired product description of the product search query. Such as described in step 204 of FIG. 2, the text embedding may be a multi-dimensional vector encoding the desired product description. In some embodiments, the text embedding is generated by encoding the desired product description into the multi-dimensional vector using machine learning, such as recurrent neural network models, long short-term memory network models, or transformer models (e.g., such as, BERT or SBERT). The encoding of the desired product description into the multi-dimensional vector may preserve the contextual meaning of the desired product description.

In some embodiments, prior to generating the text embedding, the desired product description is processed by a LM, such as an LLM. For instance, the multi-modal search system may provide the desired product description of the product search query received in step 602 to an LM hosted internally by the multi-modal search system, and the internally hosted LM may then process the desired product description and return its outputs to the multi-modal search system. In some embodiments, multi-modal search system transmits the desired product description to an externally hosted LM via the network. For instance, the LM may be hosted by a cloud computing platform. The externally hosted LM may then process the desired product description and transmit its outputs to multi-modal search system via the network. The LM may receive the desired product description, and then determine whether the desired product description includes one or more product categories, a product price, a product brand, and/or one or more product features of the desired product description. The product categories, product price, product brand, and/or product features may be any product categories, product price, product brand, and/or product features, respectively, described herein, such as described in reference to FIG. 3A. If the desired product description includes the product categories, product price, product brand, and/or product features, the LM may identify the product categories, product price, product brand, and/or product features. The identified product categories, product price, product brand, and/or product features may be stored for later use. The desired product description may then be used to generate the text embedding.

In step 606, a database of products (e.g., such as, database of multi-modal searchable products) may be searched based on the text embedding. Each product of the database of products may have a stored product text embedding and/or a plurality of stored product color vectors, such as described in step 206 of FIG. 2. Such as described in method 700 of FIG. 7, the stored product text embedding may be generated for each product by encoding data of each product (e.g., such as, product data 808 of FIGS. 8A-8E), data of each product enriched by an LM (e.g., such as, enriched product data 830 of FIGS. 8B-8E), and/or a color name (e.g., such as, color name 850 of FIGS. 8D-8E) of a dominant color of each product. In some embodiments, each product of the database of products has a plurality of stored product text embeddings. For instance, each product of the database may have a first stored product text embedding encoding the data and the at least one color of each product. Each product of the database may have a second stored product text embedding encoding the data of each product enriched by the LM. Each product of the database may have a third stored product text embedding encoding the data, the at least one color, and the enriched data of each product.

The database of products may be searched to determine at least one product of the database of products with the stored product text embedding similar to the text embedding. For instance, a similarity score between the text embedding and the stored product text embedding of each product may be determined via a vector similarity search, in which a similarity score between the text embedding and the stored product text embedding of each product is determined by calculating at least one vector distance metric between the text embedding and the stored product text embedding of each product. For instance, the similarity score may be determined by calculating a cosine distance between the text embedding and the stored product text embedding, by calculating a Euclidean distance between the text embedding and the store product text embedding, and/or a Jaccard distance between the text embedding and the stored product text embedding for each product of the database of products. In some embodiments, the similarity score may be determined for each product by calculating the at least one vector distance metric between the text embedding and the first stored product text embedding. In some embodiments, the similarity score may be determined for each product by calculating the at least one vector distance between the text embedding and the second stored product text embedding. In some embodiments, the similarity score may be determined for each product by calculating the at least one vector distance between the text embedding and the third stored product text embedding. In some embodiments, the similarity score may be determined for each product using a weighted sum of the at least one vector distance between the text embedding and the first stored product text embedding, the at least one vector distance between the text embedding and the second stored product text embedding, and/or the at least one vector distance between the text embedding and the third stored product text embedding.

The products may be ranked based on the similarity scores. For instance, the products may be ranked from largest similarity score to smallest similarity score, such that a product with a large similarity score is more similar to the product search query than a product with a small similarity score. As such, a product with the largest similarity score is the most similar to the product search query, and a product with the smallest similarity score is the least similar to the product search query. In some embodiments, the products are ranked from smallest similarity score to largest similarity score, such that a product with a small similarity score is more similar to the product search query than a product with a large similarity score.

In some embodiments, the products of the database may be filtered based on the identified product categories, product price, product brand, and/or product features of the desired product description prior to determining the similarity score. For instance, each product of the database may be filtered based on whether each product is associated with product data and/or enriched product data satisfying the identified product categories, product price, product brand, and/or product features. If a product is not associated with product categories, a product price, a product brand, and/or product features matching the identified product categories, product price, product brand, and/or product features, respectively, then the product may not be used in the similarity score determination. If a product is associated with product categories, a product price, a product brand, and/or product features matching the identified product categories, product price, product brand, and/or product features, respectively, then the product may be used in the similarity score determination.

In step 608, at least one search result may be returned to a user based on the similarity score of products of the database to the first product search query (e.g., the text embedding). The at least one search result may be the at least one product with the stored product text embedding similar to the text embedding. For instance, the at least one search result may be at least one product with a large similarity score. In some embodiments, the at least one search result is at least one product with a small similarity score. The at least one search result may be organized on the user system based on the similarity score associated with each search result, such as described in step 208 of method 200 of FIG. 2 and described in reference to FIG. 5. For instance, the at least one search result may be organized sequentially from a search result associated with the largest similarity score to a search result associated with the smallest similarity score. As such, a first search result of the at least one search result may be associated with the largest similarity score and a last search result may be associated with the smallest similarity score. In some embodiments, the at least one search result is organized sequentially from a search result associated with the smallest similarity score to a search result associated with the largest similarity score.

In some embodiments, the user desires to filter the at least one search result received in response to the first product search query by selecting a color of the product. As such, the user may filter the at least one search result by submitting a second product search query that includes a color selection. FIG. 6B illustrates an exemplary method 600b for performing a second product search using a second product search query that includes a color selection. The color selection may be any color selection described herein, such as color selection 304 of FIGS. 3A and 3B. The method 600b may be performed by a system configured for multi-modal product searching, such as system 100 of FIG. 1.

In step 610, the second product search query may be received. The second product search query may be received by a multi-modal search system, such as multi-modal search system 106 of FIG. 1. The multi-modal search system may identify at least one search result from at least one search result in accordance with a first product search query, such as a first product search query received in step 602 of method 600a of FIG. 6A, that is in accordance with the second product search query. The second product search query may be entered by a user into a product search graphical user interface (GUI) of a merchant-specific virtual storefront, or a merchant virtual storefront, displayed on a user system, such as user system 108 of FIG. 1. The product search GUI may be any product search GUI described herein, such as product search GUI 306 of FIG. 3A, first product search region 330 of FIG. 3C, or second product search region 332 of FIG. 3C. The user may submit the second product search query on the user system, and the user system may transmit the second product search query to the multi-modal search system via a network, such as network 110 of FIG. 1. In some embodiments, the user system may transmit the second product search query to an e-commerce system, such as e-commerce system 102 of FIG. 1. In some embodiments, the user system may transmit the second product search query to a merchant-specific system, such as merchant-specific system 104 of FIG. 1.

In step 612, a selected color vector may be generated based on the color selection of the second product search query. The selected color vector is generated by encoding the color selection into a multi-dimensional vector. For instance, the color selection may be represented by a plurality of values of any color model described herein, and the selected color vector may be generated by encoding the plurality of color model values, such as described in step 204 of FIG. 2. In some embodiments, the color selection is represented by a plurality of values of any color model described herein except an HSV color model, and the color selection is converted to a plurality of HSV color model values prior to being encoded in the selected color value, such as described in step 204 of FIG. 2. In some embodiments, the color selection is represented by a color name, and the color name is converted to a plurality of values of any color model described herein and then the plurality of color model values are encoded in the selected color vector, such as described herein.

In step 614, the at least one search result from the first product search query may be searched based on the selected color vector. For instance, the products associated with the at least one search result may be searched to determine at least one product with a stored product color vector similar to the selected color vector. The stored product color vector may be any stored product vector described herein, such as described in step 206 of FIG. 2. The stored product color vector may be generated a product using method 400 of FIG. 4.

The similarity score between the products associated with the at least one search result and the selected color vector may be determined via vector similarity search, in which a similarity score between the selected color vector and the stored product color vector of the products associated with the at least one search result is determined by calculating at least one vector distance metric between the selected color vector and each stored product color vector. For instance, the similarity score may be determined by calculated a Euclidean distance, a cosine distance, and/or a Jaccard distance between the selected color vector and the one stored product color vector. Such as described in step 416 of method 400 of FIG. 4, product color vectors are stored for each product in a product database structure based on a ranking of dominant colors of a product in a product image. As such, the similarity score may be determined based on the ranking associated with the stored product color vectors. For instance, the similarity score may be determined by calculating the at least one vector distance metric between the selected color vector and a first stored product color vector, such that the first stored product color vector is associated with a first ranking dominant color, such as described in method 400 of FIG. 4. In some embodiments, the similarity score may be determined by calculating the at least one vector distance metric between the selected color vector and a portion of the total number of stored product color vectors. For instance, a first vector distance metric between the selected color vector and the first stored product color vector (e.g., representing the first ranking dominant color) may be calculated and a second vector distance metric between the selected color vector and the second stored product color vector (e.g., representing the second ranking dominant color) may be calculated. The similarity score may then be determined using a weighted sum of the first vector distance metric and the second vector distance metric. In some embodiments, the similarity score may be determined by calculating the at least one vector distance metric between the selected color vector and all stored product color vectors. For instance, if a given product has three stored product color vectors, then the first vector distance metric may be calculated between the selected color vector and the first stored product color vector, the second vector distance metric may be calculated between the selected color vector and the second stored product color vector, and a third vector distance metric may be calculated between the selected color vector and the third stored product color vector. The similarity score may then be determined by calculating a weighted sum of the first, second, and third vector distance metrics.

In step 616, at least one search result may be returned to a user based on the similarity score of products to the second product search query (e.g., the selected color vector). The at least one search result may be the at least one product with the stored product color vector similar to the selected color vector. For instance, the at least one search result may be at least one product with a large similarity score. In some embodiments, the at least one search result is at least one product with a small similarity score. The at least one search result may be organized on the user system based on the similarity score associated with each search result, such as described in step 208 of method 200 of FIG. 2 and described in reference to FIG. 5. For instance, the at least one search result may be organized sequentially from a search result associated with the largest similarity score to a search result associated with the smallest similarity score. As such, a first search result of the at least one search result may be associated with the largest similarity score and a last search result may be associated with the smallest similarity score. In some embodiments, the at least one search result is organized sequentially from a search result associated with the smallest similarity score to a search result associated with the largest similarity score.

Such as described herein, products of a database of products similar to a product search query are identified by searching the database of products most similar to the product search query. However, the database of products must be generated prior to searching the database for products most similar to the product search query. FIG. 7 illustrates an exemplary method 700 for generating a database of products, such as a database of products described in method 200 of FIG. 2, method 600a of FIG. 6A, and method 600b of FIG. 6B, by generating a multi-modal searchable product entry for each product of a merchant. The method 700 may be performed by a system configured for multi-modal product searching, such as system 100 of FIG. 1.

In step 702, a multi-modal searchable product entry may be created. The multi-modal searchable product entry may be an entry of the database of products that represents a product and may be used when searching the database for products that satisfy a product search query, such as described herein. The multi-modal searchable product entry may be created by the multi-modal search system. In some embodiments, the multi-modal searchable product entry of step 702 is an empty table with a plurality of columns (or a plurality of rows) and a row (or a column). As such, the database of products may be a table with a plurality of columns and a plurality of rows, such that each row (or each column) is a multi-modal searchable product entry that represents the merchant's product.

In step 704, data associated with the product and an image of a product may be received from a product data source. For instance, the multi-modal search system may be communicatively coupled via a network, such as network 110 of FIG. 1, to an e-commerce system, such as e-commerce system 102 of FIG. 1, that stores merchant products, such that the multi-multi search system may extract (e.g., receive) the product data and the product image from the e-commerce system (e.g., product data source) via the network. In some embodiments, the multi-modal search system is communicatively coupled via the network to a merchant-specific system, such as merchant-specific system 104 of FIG. 1, that stores the merchant's products, such that the multi-modal search system extracts the product data and the product image from the merchant-specific system. In some embodiments, a plurality of images of the product are extracted from the e-commerce system and/or the merchant-specific system.

The product data may be any data associated with the product. For instance, the product data may include a product name, product brand, product price, product price variants, product description, and/or product tags. Such as described in reference to the desired product description 302 of FIG. 3A, the product brand may be any brand name of the product. Such as described in reference to the desired product description 302 of FIG. 3A, the product price may be any numeric price of the product and/or any word, phrase, and/or symbol of the price of the desired product.

The product name may be any word or phrase entitling the product. For instance, the product name may be the name of the product included on a virtual listing of the product on the merchant's virtual storefront. The product name may be copied from the virtual listing. In some embodiments, the product name is a cropped version of the name of the virtual listing. For instance, the product name may be a first word of the name of the virtual listing.

The product price variants may be any alternative prices of the product. The alternative prices of the product may be a suggested price of the product (e.g., such as, a price suggested by a manufacturer of the product), a previous price of the product (e.g., the price of the product is a sale price of the product), etc. The product price variants may be singular numeric prices, such as 49.99, 5.00, 5, 100, etc. Additionally, the product price variants may be any words, phrases, and/or symbols of the alternative price of the product. For instance, the product price variants may be the singular numeric values with currency symbols, such as $49.99, 5$, $5.00, etc. The product price variants may be the singular numeric values with currency words. For instance, the price may be 49.99 dollars, 5.00 euros, etc. The product price variants may be the singular numeric values with currency phrases. For instance, the product price variants may be “less than 50 dollars”, “greater than 10 dollars”, etc. In some embodiments, each product price variant is a plurality of numeric values with a word, phrase, and/or symbol. For instance, the product price variants may be “45-75 dollars”, “$45-$75”, “greater than 45 dollars but less than $ 75”, etc. In some embodiments, the product price variants are alternatively any word, phrase, and/or symbol. For instance, the product price variants may be “five dollars,” “ten dollars,” “greater than ten dollars,” “less than one hundred dollars,” etc. In some embodiments, the product has a price variant. In some embodiments, the product has a plurality of price variants.

The product description may be a description of the product that was generated by the merchant and may be natural language (e.g., natural language sentence(s) with punctuation, natural language sentence(s) without punctuation, natural language partial sentence(s)), at least one keyword, or any combination of the natural language and the at least one keyword. For instance, the product description may be the description of the product included on a virtual listing of the product on the merchant's virtual storefront. The product description may be copied from the virtual listing. In some embodiments, the product description is a cropped version of the description of the virtual listing. For instance, if the product description of the virtual listing is greater than 250 words, greater than 200 words, greater than 150 words, or greater than 100 words, then the product description may be the description of the virtual listing cropped to less than 100 words, less than 150 words, less than 200 words, or less than 250 words.

The product tags may be any word or phrase categorizing the product. For instance, the product tags may be the product category, the product subcategory, and/or the product brand. In some embodiments, the product tags are words and/or phrases from the description of the product. In some embodiments, the product tags are other words or phrases not previously stated by the product's category, subcategory, brand, price, price variants, and description.

The product image extracted from the merchant may be a uniform resource locator (URL) of the image displayed on the product listing of the merchant's virtual storefront. In some embodiments, the product image is extracted from the merchant by downloading the product image from the product listing of the merchant's virtual storefront (e.g., the multi-modal search system has at least one downloaded copy of the product image). In some embodiments, the product image extracted from the merchant is the first image of the product listing of the merchant's virtual storefront (e.g., the product image that is displayed first on the product listing of the merchant's virtual storefront). In some embodiments, the plurality of product images extracted from the merchant is all product images of the product listing (e.g., all product images associated with the product of the product listing). In some embodiments, the plurality of product image extracted from the merchant is a portion of the images of the product of the product listing (e.g., a portion of the images associated with the product of the product listing).

In step 706, the product data and the product image may be entered into the multi-modal searchable product entry of the database of products. As such, the multi-modal searchable product entry of the database of products may be updated with the product data and the product image (or the plurality of images). For instance, each portion of the product data (e.g., the product name, product brand, product price, product price variants, product description, and/or product tags) may be entered into a column (or a row) of the multi-modal searchable product entry. Similarly, the product image, such as a (URL) of the product image, may be entered into a column (or a row) of the multi-modal searchable product entry. As such, each portion of the product data and the product image has a separate column (or row) of the multi-modal searchable product entry. In some embodiments, the plurality of product images is entered into the multi-modal searchable product entry, such that each product image is entered into a column (or a row) of the multi-modal searchable product entry. FIG. 8A illustrates an exemplary database of products 800 with a first exemplary multi-modal searchable product entry 802, a second exemplary multi-modal searchable product entry 804, and a third exemplary multi-modal searchable product entry 806. Such as illustrated in FIG. 8A, the first, second, and third multi-modal searchable product entries may be labeled via an index 812, such that each multi-modal searchable product entry may be accessed by its index 812. Each multi-modal searchable product entry may include product data 808 and a product image 810 that are associated with a product inherent to each multi-modal searchable product entry. The product data 808 and the product image 810 of each multi-modal searchable product entry may be extracted, such as described in step 704 of FIG. 7, and entered into each multi-modal searchable product entry, such as described in step 706 of FIG. 7. The product data 808 entered into each multi-modal searchable product entry may include a name 814, a brand 816, a price 818, at least one price variant 820, a description 822, and/or tags 824 of the product. The product name 814 may be any product name described herein, such as described in step 704 of FIG. 7. The product brand 816 may be any product brand described herein, such as described in reference to desired product description 302 of FIG. 3A or in step 704 of FIG. 7. The product price 818 may be any product price described herein, such as described in reference to desired product description 302 of FIG. 3A or in step 704 of FIG. 7. The at least one product price variant 820 may be any product price variant described herein, such as described in step 704 of FIG. 7. The product description 822 may be any product description described herein, such as described in step 704 of FIG. 7. The product tags 824 may be any tags described herein, such as described in step 704 of FIG. 7.

Referring back to FIG. 7, in step 708, the product image and at least a portion of the product data may be processed by a LM, such as an LLM, configured to enrich the product data using the product image and at least portion of the product data. For instance, the product name, the product brand, the product price, the product price variants, the product description, and/or the product tags may be processed by the LM. Such as described herein, the LM may be internally hosted by the multi-modal search system or externally hosted, such as by a cloud computing platform. In some embodiments, the plurality of product images and at least portion of the product data may be processed by the LM. The LM may be configured to enrich the product data using prompt engineering, in which prompts provided to the LM are specifically engineered to produce outputs that enrich the product data. As such, the LM may be configured to enrich the product data by responding to a series of prompts provided to the LM. For instance, the prompt engineering may guide the LM to enrich the product data by determining a product gender, a product category, and/or a product subcategory, and/or generating an enriched product description of the product. The enriched description may be a description of the product in natural language (e.g., natural language sentence(s) with punctuation, natural language sentence(s) without punctuation, natural language partial sentence(s)). The enriched product description may include the portion of the product data provided to the LM, the product gender determined by the LM, the product category determined by the LM, and/or the product subcategory determined by the LM. The enriched product description may alternatively, or additionally, include one or more product features, such as a product style, product occasion, or product material, such as described in reference to FIG. 3A. Such as described in reference to desired product description 302 of FIG. 3A, the product occasion may be any word or phrase describing when or why the product would be used, worn, or otherwise interacted with. Such as described in reference to desired product description 302 of FIG. 3A, the product gender may be male (or any synonym of male, such as dude, guy, fellow, etc.), female (or any synonym of female, such as lady, woman, girl, etc.), or unisex (or any synonym of unisex, such as androgynous, genderless, etc.). In some embodiments, the product gender may be masculine (or any synonym of masculine), feminine (or any synonym of feminine), or unisexual (or any synonym of unisexual).

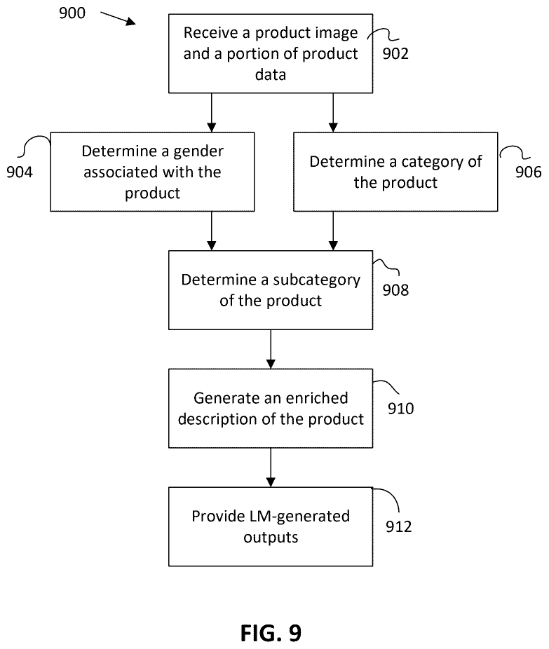

FIG. 9 illustrates an exemplary method 900 of enriching product data by determining a product gender, product category, and product subcategory, and generating an enriched product description using an LM, such as an LLM, configured to enrich the product data. In step 902, the LM may receive an image of a product and at least a portion of data of a product, such as described in step 708 of FIG. 7. In some embodiments, the LM receives a plurality of images of the product. In step 904, the LM may determine a gender of the product associated with the product image and the portion of product data. For instance, if the product is a fashion product, then the LM may determine the gender of the model wearing the fashion product. In some embodiments, the LM may determine the gender of the product by extracting the gender from the portion of product data. For instance, the gender may be included in a description of the product, and the description may be included in the portion of product data received by the LM in step 902.

In step 906, the LM may determine a category of the product. Such as described in reference to desired product description 302 of FIG. 3A, the product category may be any word or phrase (e.g., a plurality of words with or without punctuation) that broadly categorizes the product. In some embodiments, the LM may determine the product category by extracting category-like words or phrases from the description included in the portion of product data received by the LM in step 902.

In step 908, the LM may determine a subcategory of the product. Such as described in reference to desired product description 302 of FIG. 3A, the product subcategory may be any word or phrase that categorizes the desired product into a narrower category (e.g., a secondary category). The LM may determine the product subcategory by extracting subcategory-like words or phrases from the description included in the portion of product data received by the LM in step 902. In some embodiments, the product gender determined in step 904 informs the subcategory determined in step 908. For instance, if the product is a fashion product, and the LM determined in step 904 that the product gender associated with the product is female and the LM determined in step 906 that the product category is a top, then the LM may determine that the product subcategory of the top using conventionally female-oriented top subcategories, such as blouse, cold shoulder top, peplum top, etc.

In step 910, the LM may generate an enriched product description. Such as described in step 708 of FIG. 7, the enriched product description may be a description of the product in natural language (e.g., natural language sentence(s) with punctuation, natural language sentence(s) without punctuation, natural language partial sentence(s)). The LM may use the product image, at least a portion of product data, the product gender, the product category, and/or the product subcategory in generating the enriched product description. The enriched product description may include one or more product features, such as a product style, a product occasion, and/or a product material, such as described in step 708 of FIG. 7.

In step 912, the LM provides LM-generated outputs (or LLM-generated outputs if an LLM is used) to the multi-modal search system, and the LM-generated outputs may include the product gender, the product category, the product subcategory, and/or the enriched product description. The product gender, the product category, the product subcategory, and the enriched product description may enrich the product data, as the aforementioned provide additional information about the product either previously undescribed (e.g., such as, the at least one product style or the at least one product occasion) and/or previously visually described in the image (e.g., such as, the product gender and/or the at least one product feature).

Referring back to FIG. 7, in step 710, enriched product data may be received from the LM. Such as described in step 912 of method 900 of FIG. 9, the LM may output LM-generated outputs, such as the product gender, the product category, the product subcategory, and/or the enriched product description. As such, the enriched product data received from the LM may include the product gender, the product category, the product subcategory, and/or the enriched product description of the product.

In step 712, the enriched product data may be entered into the multi-modal searchable product entry of the database of products that already includes the product data and the at least one product image. As such, the multi-modal searchable product entry of the database of products may be updated with the enriched product data. For instance, each portion of the enriched product data (e.g., the product gender, product category, product subcategory, and/or enriched product description) may be entered into a column (or a row) of the multi-modal searchable product entry. As such, each portion of the enriched product data has a separate column (or row) of the multi-modal searchable product entry. FIG. 8B illustrates the exemplary database of products 800 with the first exemplary multi-modal searchable product entry 802, the second exemplary multi-modal searchable product entry 804, and the third exemplary multi-modal searchable product entry 806 that include the product data 808, the product image 810, and enriched product data 830. The enriched product data 830 may be received from an LM, such as an LLM, configured to enrich product data, such as described in step 708 and step 710 of method 700 of FIG. 7. The enriched product data 830 entered into each multi-modal searchable product entry may include a product gender 832 determined by the LM, a product category 834 determined by the LM, a product subcategory 836 determined by the LM, and an enriched product description 838. The product gender 832 may be any product gender described herein, such as described in step 904 of method 900 of FIG. 9 or described in reference to desired product description 302 of FIG. 3A. The product category 834 may be any product category described herein, such as described in step 906 of method 900 of FIG. 9 or described in reference to the desired product description 302 of FIG. 3A. The product subcategory may be any product subcategory described herein, such as described in step 908 of method 900 of FIG. 9 or described in reference to the desired product description 302 of FIG. 3A. The enriched product description 838 may be any enriched LM description described herein, such as described in step 910 of method 900 of FIG. 9.

Referring back to FIG. 7, in step 714, a plurality of product color vectors may be determined for the product image. For instance, the plurality of product color vectors may be determined for the product image using the method 400 of FIG. 4.

In step 716, the plurality of product color vectors may be entered into the multi-modal searchable product entry of the database of products that already includes the product data, the at least one product image, and the enriched product data. As such, the multi-modal searchable product entry of the database of products may be updated with the plurality of product color vectors. For instance, each product color vector of the plurality of product color vectors may be entered into a column (or a row) of the multi-modal searchable product entry. As such, each product color vector of the plurality of product color vectors has a separate column (or row) of the multi-modal searchable product entry. In some embodiments, a calculated percentage associated with each product color vector is entered into the multi-modal searchable product entry, such as the calculated percentage described in step 408 of method 400 of FIG. 4. In some embodiments, a plurality of HSV color model values associated with each product color vector is entered into the multi-model searchable product entry, such as the plurality of HSV color model values described in step 412 of method 400 of FIG. 4. FIG. 8C illustrates the exemplary database of products 800 with the first exemplary multi-modal searchable product entry 802, the second exemplary multi-modal searchable product entry 804, and the third exemplary multi-modal searchable product entry 806 that includes the product data 808, the product image 810, the enriched product data 830, and a plurality of product color vectors 840. The plurality of product color vectors 840 may be generated via method 400 of FIG. 4 and may be entered into the database of products 800, such as described in step 716 of method 700 of FIG. 7. The plurality of product color vectors 840 entered into each multi-modal searchable product entry may include a first product color vector 842, a second product color vector 844, and/or a third product color vector 846. The first product color vector 842 may be associated with a dominant color of the product with the highest ranking, such as described in step 410 of method 400 of FIG. 4. The second product color vector 844 may be associated with a dominant color of the product with the second highest ranking, such as described in step 410 of method 400 of FIG. 4. The third product color vector 846 may be associated with a dominant color of the product with the third highest ranking, such as described in step 410 of method 400 of FIG. 4. In some embodiments, a calculated percentage and/or a plurality of HSV color model values associated with the first product color vector 842 may be entered into each multi-modal searchable product entry. In some embodiments, a calculated percentage and/or a plurality of HSV color model values associated with the second product color vector 844 may be entered into each multi-modal searchable product entry. In some embodiments, a calculated percentage and/or a plurality of HSV color model values associated with the third product color vector 846 may be entered into each multi-modal searchable product entry.

Referring back to FIG. 7, in step 718, a color name of the dominant color associated with the first product color vector may be determined. For instance, the color name may be determined based on a similarity between the plurality of HSV color model values associated with the first product color vector and a plurality of HSV color model values associated with a plurality of pre-defined color names (e.g., each color name may be associated with a plurality of HSV color model values) stored in the multi-modal search system (e.g., in a lookup table). The similarity may be determined by calculating a Euclidean distance. In some embodiments, the color name of the plurality of color names associated with the smallest similarity is determined to be the color name of the dominant color associated with the first product color vector. In some embodiments, the color name of the plurality of color names associated with the largest similarity is determined to be the color name of the dominant color associated with the first product color vector.

In step 720, the color name of the dominant color associated with the first product color vector may be entered into the multi-modal searchable product entry of the database of products that already includes the product data, the at least one product image, the enriched product data, and the plurality of product color vectors. As such, the multi-modal searchable product entry of the database of products may be updated with the color name. For instance, the color name may be entered into a column (or a row) of the multi-modal searchable product entry. FIG. 8D illustrates the exemplary database of products 800 with the first exemplary multi-modal searchable product entry 802, the second exemplary multi-modal searchable product entry 804, and the third exemplary multi-modal searchable product entry 806 that includes the product data 808, the product image 810, the enriched product data 830, the plurality of product color vectors 840, and a color name 850. The color name 850 may be the name of the color of the dominant color associated with the first product color vector 842.

Referring back to FIG. 7, in step 722, at least one data embedding may be generated. The at least one data embedding may encode the product data, the product image(s), the enriched product data, and/or the color name. The at least one data embedding may be generated using machine learning, such as recurrent neural network models, long short-term memory network models, or transformer models (e.g., such as, BERT or SBERT). The encoding of the product data, the product image(s), the enriched data, and/or the color name may preserve the contextual meaning of the product data, the product image(s), the enriched data, and/or the color name, respectively. In some embodiments, the product data, the product image(s), the enriched product data, and the color name are encoded into a first data embedding, a second data embedding, a third data embedding, and a fourth data embedding, respectively. In some embodiments, the product image, or the plurality of product images, is embedded into a first data embedding, the enriched product data is embedded into a second data embedding, the product data and the color name are embedded into a third data embedding, and the product data, the enriched product data, and the color name are embedded into a fourth data embedding.

In step 724, the at least one data embedding is entered into the multi-modal searchable product entry of the database of products that already includes the product data, the product image, the enriched product data, the plurality of product color vectors, and the color name. As such, the multi-modal searchable product entry of the database of products is updated with the at least one data embedding. For instance, each data embedding of the at least one data embedding may be entered into a column (or a row) of the multi-modal searchable product entry. As such, each data embedding of the at least one data embedding has a separate column (or row) of the multi-modal searchable product entry. FIG. 8E illustrates the exemplary database of products 800 with the first exemplary multi-modal searchable product entry 802, the second exemplary multi-modal searchable product entry 804, and the third exemplary multi-modal searchable product entry 806 that includes the product data 808, the product image 810, the enriched product data 830, the plurality of product color vectors 840, the color name 850, and at least one data embedding 860. The at least one data embedding 860 may be generated via step 722 of method 700 of FIG. 7 and may be entered into the database of products 800, such as described in step 724 of method 700 of FIG. 7. The at least one data embedding 860 entered into each multi-modal searchable product entry may include a data embedding 862. The data embedding 862 may encode the product data 808, the product image 810, the enriched product data 830, and/or the color name 850. In some embodiments, the at least one data embedding 860 includes a plurality of data embeddings 864. For instance, the at least one data embedding 860 may include a first data embedding that encodes the product data 808, a second data embedding that encodes the product image 810, a third data embedding that encodes the enriched product data 830, and a fourth data embedding that encodes that color name 850. In some embodiments, the at least one data embedding 860 includes a first data embedding that encodes the product image 810, a second data embedding that encodes the enriched product data 830, a third data embedding that encodes the product data 808 and the color name 850, and a fourth data embedding that encodes the product data 808, the enriched product data 830, and the color name 850.

FIG. 10 illustrates an example of a computing system 1000 that may be used for any one of the computing systems and devices described herein, such as for e-commerce system 102 of FIG. 1, merchant-specific system 104 of FIG. 1, multi-modal search system 106 of FIG. 1, and/or user system 108 of FIG. 1. System 1000 can be a computer connected to a network. System 1000 can be a client computer, a server, a router, a hub, an access point, or any other computing device that can send and/or receive wireless signals or non-wireless signals. As shown in FIG. 10, system 1000 can be any suitable type of microprocessor-based system, such as a personal computer, workstation, server, or handheld computing device (portable electronic device) such as a phone or tablet. The system can include, for example, one or more of a processor 1010, input device 1020, output device 1030, storage 1040, and communication device 1060. Input device 1020 and output device 1030 can generally correspond to those described above and can either be connectable or integrated with the computer.

Input device 1020 can be any suitable device that provides input, such as a touch screen, keyboard or keypad, mouse, gesture recognition component of a virtual/augmented reality system, or voice recognition device. Output device 1030 can be or include any suitable device that provides output, such as a touch screen, haptics device, virtual/augmented reality display, or speaker.

Storage 1040 can be any suitable device that provides storage, such as an electrical, magnetic, or optical memory, including a RAM, cache, hard drive, removable storage disk, or other non-transitory computer-readable medium. Communication device 1060 can include any suitable device capable of transmitting and receiving signals over a network, such as a network interface chip or device. The components of the computer can be connected in any suitable manner, such as via a physical bus or wirelessly.

Software 1050, which can be stored in storage 1040 and executed by processor 1010, can include, for example, the programming that embodies the functionality of the present disclosure (e.g., as embodied in the devices as described above). For example, software 1050 can include one or more programs for performing one or more of the steps of method 200 of FIG. 2, method 400 of FIG. 4, method 600a of FIG. 6A, method 600b of FIG. 6B, method 700 of FIG. 7, and/or method 900 of FIG. 9.

Software 1050 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1040, that can contain or store programming for use by or in connection with an instruction execution system, apparatus, or device.

Software 1050 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

System 1000 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 1000 can implement any operating system suitable for operating on the network. Software 1050 can be written in any suitable programming language, such as C, C++, Java, PostgresSQL, Javascript, or Python. In various aspects, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for multi-modal product searching comprising, at a computing system:
receiving a product search query comprising a desired product description and a color selection;
generating a text embedding based on the desired product description and a selected color vector based on the color selection;
searching a database of products, wherein searching the database of products comprises:
calculating a first similarity score between the text embedding and stored product text embeddings,
calculating a second similarity score between the selected color vector and stored product color vectors, and
calculating combined scores comprising weighted sums of the first similarity score and the second similarity score; and
returning at least one search result to the user based on the combined scores.

2. The method of claim 1, wherein the first similarity score, the second similarity score, or both, is a Euclidean distance, a cosine distance, or a Jaccard distance.

3. The method of claim 1, wherein the color selection is in a red-green-blue color model, and wherein generating the selected color vector comprises converting from the red-green-blue color model to a hue-saturation-value color model, wherein the selected color vector comprises a sine of hue and a cosine of hue.

4. The method of claim 1, wherein an entry for a product in the database of products comprises a plurality of stored product color vectors.

5. The method of claim 4, wherein the plurality of stored product vectors comprises at least three stored product color vectors.

6. The method of claim 1, wherein for a product in the database of products, a stored product text embedding for the product comprises an embedding generated by using a language model to generate a description from an image of the product.

7. The method of claim 1, wherein for a product in the database of products, each stored product color vector for the product was generated by masking skin from an image of the product.

8. The method of claim 1, comprising determining whether the desired product description comprises a category, a brand, a price, or at least one feature of the desired product prior to generating the text embedding based on the desired product description.

9. The method of claim 8, wherein if the desired product description comprises the category, brand, price, or at least one feature of the desired product, searching the database of products comprises filtering out products from the database of products that do not comprise the category, brand, price, or at least one feature of the desired product.

10. The method of claim 1, wherein a weight applied to the first similarity score is larger than a weight applied to the second similarity score.

11. A computing system for multi-modal product searching comprising one or more processors and memory storing one or more programs, the one or more programs including instructions that when processed by the one or more processors cause the computing system to:
receive a product search query comprising a desired product description and a color selection;
generate a text embedding based on the desired product description and a selected color vector based on the color selection;
search a database of products, wherein searching the database of products comprises:
calculating a first similarity score between the text embedding and stored product text embeddings,
calculating a second similarity score between the selected color vector and stored product color vectors, and
calculating combined scores comprising weighted sums of the first similarity score and the second similarity score; and
return at least one search result to the user based on the combined scores.

12. The system of claim 11, wherein the first similarity score, the second similarity score, or both, is a Euclidean distance, a cosine distance, or a Jaccard distance.

13. The system of claim 11, wherein the color selection is in a red-green-blue color model, and wherein generating the selected color vector comprises converting from the red-green-blue color model to a hue-saturation-value color model, wherein the selected color vector comprises a sine of hue and a cosine of hue.

14. The system of claim 11, wherein an entry for a product in the database of products comprises a plurality of stored product color vectors.

15. The system of claim 14, wherein the plurality of stored product color vectors comprises at least two stored product color vectors.

16. The system of claim 11, wherein for a product in the database of products, a stored product text embedding for the product comprises an embedding generated by using a language model to generate a description from an image of the product.

17. The system of claim 11, wherein for a product in the database of products, each stored product color vector for the product was generated by masking skin from an image of the product.

18. The system of claim 11, the one or more programs include instructions that when processed by the one or more processors cause the computing system to determine whether the desired product description comprises a category, a brand, a price, or at least one feature of the desired product prior to generating the text embedding based on the desired product description.

19. The system of claim 18, wherein if the desired product description comprises the category, brand, price, or at least one feature of the desired product, searching the database of products comprises filtering out products from the database of products that do not comprise the category, brand, price, or at least one feature of the desired product.

20. The system of claim 11, wherein a weight applied to the first similarity score is larger than a weight applied to the second similarity score.

21. A method for multi-modal product searching comprising, at a computing system:
receiving data associated with a product from a product data source, the data comprising a text description of a product and at least one image of the product;
generating an enriched description of the product by processing the text description and the at least one image by a language model;
generating at least one embedding based on the enriched description of the product; and
updating an entry for the product in a database with the embedding.

22. The method of claim 21, wherein the at least one embedding comprises an embedding generated from the enriched description of the product and the text description of the product.

23. The method of claim 21, comprising generating an embedding based on the at least one image of the product.

24. The method of claim 21, comprising receiving a search query from a user and determining a relevance of the product to the search query based on the embedding.

25. The method of claim 21, comprising generating at least one product color vector from the at least one image of the product.

26. The method of claim 21, wherein the product data source comprises an e-commerce system.

27. The method of claim 21, wherein generating an enriched description of the product by processing the text description and the at least one image by a language model comprises exchanging a series of prompts and responses with the language model.

28. A computing system for multi-modal product searching comprising one or more processors and memory storing one or more programs, the one or more programs including instructions that when processed by the one or more processors cause the computing system to:
receive data associated with a product from a product data source, the data comprising a text description of a product and at least one image of the product;
generate an enriched description of the product by processing the text description and the at least one image by a language model;
generate at least one embedding based on the enriched description of the product; and
update an entry for the product in a database with the embedding.

29. The system of claim 28, wherein the at least one embedding comprises an embedding generated from the enriched description of the product and the text description of the product.

30. The system of claim 28, the one or more programs include instructions that when processed by the one or more processors cause the computing system to generate an embedding based on the at least one image of the product.

31. The system of claim 28, the one or more programs include instructions that when processed by the one or more processors cause the computing system to receive a search query from a user and determine a relevance of the product to the search query based on the embedding.

32. The system of claim 28, the one or more programs include instructions that when processed by the one or more processors cause the computing system to generate at least one product color vector from the at least one image of the product.

33. The system of claim 28, wherein the product data source comprises an e-commerce system.

34. The system of claim 28, wherein processing the text description and the at least one image by a language model comprises exchanging a series of prompts and responses with the language model.
